(19) United States
(12) Patent Application Publication
(10) Pub. No.: US 2009/0005557 A1
(43) Pub. Date: Jan. 1, 2009

(54) Electron-Conjugated Organic Silane Compound and Production Method Thereof

(76) Inventors: Masatoshi Nakagawa, Nara (JP); Hiroyuki Hanato, Nara (JP); Toshihiro Tamura, Nara (JP)

Correspondence Address: NIXON & VANDERHYE, PC, 901 NORTH GLEBE ROAD, 11TH FLOOR, ARLINGTON, VA, 22203, US

(21) Appl. No.: 11/631,122

(22) PCT Filed: Jul. 4, 2005
(86) PCT No.: PCT/JP2005/012344

§ 371 Date: Dec. 29, 2006

(30) Foreign Application Priority Data
Jul. 21, 2004 (JP) 2004-212921
Aug. 24, 2004 (JP) 2004-243505

(51) Int. Cl. C07F 7/08; C07F 7/18; C07F 7/12

(52) U.S. Cl. 544/35; 556/406; 549/4; 548/110; 549/214; 548/406; 544/229; 544/69

(57) ABSTRACT

The present invention provides a π-electron-conjugated organice silane compound that give an organic thin film superior in peeling restance, orientation, crystallinity and eletroconductive properties, and a production method thereof.

A π-electron-conjugated organice silane compound represented by General Formula: R¹-SiX¹X²X³ (R¹ represents an organic group having a particular monocyclic heterocyclic unit; and X¹ to X³ are a group giving a hydroxyl group by hydrolysis). A method of producing the organic silane compound, comprising allowing a compound represented by General Formula: R¹-Li (R¹ is the same as above) or a compound represented by General Formula: R¹-MgX⁵ (R¹ is the same as above; and X⁵ represents a halogen atom) with a compound represented by General Formula: X⁴-SiX¹X²X³ (X¹ to X³ are the same as above; and X⁴ represents a hydrogen or halogen atom or a lower alkoxy group).

A π-electron-conjugated organic silane compound represented by General Formula; Z-(R¹¹)ₘ-SiR¹²R¹³R¹⁴ (Z represents a organice group derived froma particular fused polycyclic heterocyclic compound; R¹¹ represents a bivalent organic group; m is 0 to 10; and R¹² to R¹⁴ represents a halogen atom or an alkoxy group). A method of producing the organic silane compound, comprising allowing a compound represented by General Formula: Z-(R¹¹)ₘ-MgX³⁰ (Z, R¹¹ and m are the same as above; and X³⁰ represents a halogen atom) to react with a compound represented by General Formula: X³¹-SiR¹²R¹³R¹⁴ (X³¹ represents a hydrogen or halogen atom or an alkoxy group; and R¹² to R¹⁴ are the same as above).

### TECHNICAL FIELD

The present invention relates to a π-electron-conjugated organic silane compound and a production method thereof, in particular, to a new π-electron-conjugated organic silane compound useful as an electric material and superior in conductivity or semiconductivity and a production method thereof.

### BACKGROUND ART

Recently under progress is research and development on semiconductors of an organic compound (organic semiconductors), because these semiconductors are simpler in production and easier in processing than semiconductors of an inorganic material and compatible with expansion in size of the device, allow cost down by mass production, and have functions wider in variety than those from an inorganic material, and such organic semiconductors have been reported.

In particular, TFTs having greater mobility are known to be produced by using an organic compound containing a π-electron-conjugated molecule. A typical example of the organic compound reported is pentacene (for example, Nonpatent Literature 1). The literature discloses that it is possible to prepare a TFT having a mobility greater than that of amorphous silicon, specifically an electric-field-effect mobility of 1.5 cm²/Vs by preparing an organic semiconductor layer of pentacene and forming a TFT with the organic semiconductor layer.

However, as described in the literature, production of the organic semiconductor layer for obtaining an electric-field-effect mobility higher than that of amorphous silicon demands a vacuum process such as resistance-heating vapor deposition or molecular-beam vapor deposition, making the production process more complicated and giving a crystalline film only under a particular condition. The adsorption of the organic compound film on substrate is only physical adsorption, raising a problem of easy exfoliation of the film because of lower adsorption intensity of the film on substrate. Normally, a film-forming substrate is, for example, previously rubbed for control of the orientation of the organic compound molecules in film to some extent, but there is no report that it is possible to control the alignment and orientation of compound molecules physically adsorbed at the interface between the organic compounds and the substrate in the physical absorption.

Recently on the other hand, self-structured films of an organic compound, which can be produced in a simpler process, are attracting attention, from the point of the order of film (crystallinity-orientation), which exerts a great influence on the electric-field-effect mobility, a typical indicator of the TFT characteristics, and thus, research by using such a film is under progress. The self-structured film is a film in which part of an organic compound is bound to the functional group on the substrate surface, and also a film having extremely fewer defects and high order, i.e., crystallinity. The self-structured film can be formed on a substrate easily, because the production method is quite simple. Normally known as the self-structured films are a thiol film formed on a gold substrate and a silicon compound film formed on a substrate (such as silicon substrate) having hydroxyl group sticking out of the surface formed by hydrophilizing treatment. In particular, silicon compound films are attracting attention, because they have high durability. The silicon compound films have been used as a water-repellent coating film, and are formed by using a silane-coupling agent having an alkyl or fluoroalkyl group higher in water-repellent efficiency as its organic functional group.

However, the electric conductivity of the self-structured film is determined by the organic functional group in the silicon compound contained in film, and there is no commercially available silane-coupling agent containing a π-electron-conjugated molecule in the organic functional group, and thus, it is difficult to provide the self-structured film with conductivity. Accordingly, there exists a need for a silicon compound suitable for the device such as TFT and containing a π-electron-conjugated molecule as the organic functional group. Another factor exerting a great influence of the electric-field-effect mobility is the electric properties of the raw organic molecule. Generally, the flow rate of electric current in an organic thin film depends significantly on the efficiency of electron transport from an organic material molecule to another organic material molecule in the organic thin film. Because a smaller band gap leads to increase in electric flow rate, the electronic flow rate depends largely on the molecular orbital (in particular, HOMO and LUMO) of the organic material molecule.

Compounds having a thiophene ring as its functional group at the molecular terminal in which the thiophene ring is bound via a straight-chain hydrocarbon group to a silicon atom were proposed as the silicon compounds (for example, Japanese Patent No. 2889768, Patent Document 1).

### Nonpatent Literature 1: IEEE Electron Device Lett., 18, 606-608 (1997)

### Patent Document 1: Japanese Patent No. 2889768

### DISCLOSURE OF THE INVENTION

### Technical Problems to be Solved

However, with the compound proposed in Patent Document 1, it was possible to prepare a self-structured film chemically adsorbable on the substrate but not necessarily possible to form an organic thin film superior in orientation, crystallinity, and electroconductive property that can be used in electronic devices such as TFT.

There should be high intermolecular attractive force for obtaining high orientation, i.e., high crystallinity. The intermolecular force includes an attractive force factor and a repulsive factor, and the former factor is inversely proportional to the intermolecular distance to the sixth power, while the latter factor, to the intermolecular distance to the twelfth power. Thus, the intermolecular force, sum of the attractive and repulsive force factors, has the relationship shown in FIG. 2. The minimum point in FIG. 2 (region indicated by an arrow in the Figure) is called van der Waals radius, i.e., an intermolecular distance at which the intermolecular attractive force is highest in combination of the attractive and repulsive force factors. Accordingly, it is important to make the intermolecular distance as close to the van der Waals' radius as possible, to obtain higher crystallinity. For that reason, in a vacuum process such as resistance-heating vapor deposition or molecular-beam vapor deposition, it was possible to obtain high orientation, i.e., high crystallinity only under a particular condition by controlling the intermolecular interaction between π-electron-conjugated molecules adequately. It is thus possible to obtain high electroconductive property only by adjusting the crystallinity based on the intermolecular interaction.

Although the compound may be adsorbed chemically on the substrate by forming a Si—O—Si two-dimensional network and oriented by intermolecular interaction of the particular long-chain alkyl groups, it still had problems that the intermolecular interaction is weak and that the width of the π-electron conjugation system essential for electric conductivity is very limited, because only its functional group, a thiophene molecule, contributes to the π-electron conjugation system. Even if it is possible to increase the number of the functional groups, i.e., thiophene molecules, it is still difficult to balance the intermolecular interaction as a factor determining the film orientation between the long-chain alkyl section and the thiophene section.

As for electroconductive property, the functional group, i.e., a thiophene molecule, which has a greater HOMO-LUMO energy gap, had a problem that it did not give sufficient carrier mobility even if used in the organic semiconductor layer, for example, of TFT. The characteristics of a device using an organic thin film are determined by two factors, orientation of the organic thin film and electric properties of the material molecule, but, as described above, there were many reports on improvement in the orientation of organic thin film, but there was almost no report based on consideration both of orientation of the organic thin film and electrical properties of the material molecule.

An object of the present invention, which was made under the circumstance above, is to provide a π-electron-conjugated organic silane compound that gives an organic thin film by crystallization in a simple production process, allows tight adsorption of the organic thin film obtained on the surface of a substrate, prohibiting physical exfoliation, and is superior in orientation, crystallinity, electroconductive properties, and a production method thereof.

Another object of the present invention is to provide a new π-electron-conjugated organic silane compound ensuring a sufficient high carrier mobility when used in a semiconductor electron device such as TFTs and a production method thereof.

### Means to Solve the Problems

The present invention relates to a π-electron-conjugated organic silane compound represented by General Formula (I):

R¹—SiX¹X²X³ (I)

(wherein, R¹ represents an organic group that may be substituted, having a monocyclic heterocyclic unit containing an atom selected from the group consisting of the elements in the 4A, 4B, 5B and 6B groups of the long-form periodic table; each of X¹ to X³ represents a group giving a hydroxyl group by hydrolysis).

The present invention also relates to a method of producing the π-electron-conjugated organic silane compound, comprising allowing a compound represented by General Formula (II):

R¹—Li (II)

(wherein, R¹ represents an organic group that may be substituted, having a monocyclic heterocyclic unit containing an atom selected from the group consisting of the elements in the 4A, 4B, 5B and 6B groups of the long-form periodic table) or a compound represented by General Formula (IV):

R¹—MgX⁵ (IV)

(wherein, R¹ represents an organic group that may be substituted, having a monocyclic heterocyclic unit containing an atom selected from the group consisting of the elements in the 4A, 4B, 5B and 6B groups of the long-form periodic table; and X⁵ represents a halogen atom), with a compound represented by General Formula (III):

X⁴—SiX¹X²X³ (III)

(wherein, X¹ to X³ represent a group giving a hydroxyl group by hydrolysis; and X⁴ represents a hydrogen or halogen atom or a lower alkoxy group).

The present invention relates to a π-electron-conjugated organic silane compound represented by General Formula (α):

Z-(R¹¹)ₘ—SiR¹²R¹³R¹⁴ (α)

(wherein, Z represents a monovalent organic group derived from a fused polycyclic heterocyclic compound having 2 to 10 of fused rings of five-membered rings and/or six-membered rings; R¹¹ represents a bivalent organic group; m is an integer of 0 to 10; and R¹² to R¹⁴ each independently represent a halogen atom or an alkoxy group having 1 to 4 carbon atoms).

The present invention also relates to a method of producing the electron-conjugated organic silane compound, comprising allowing a compound represented by General Formula (β):

Z-(R¹¹)ₘ—MgX³⁰ (β)

(wherein, Z represents a monovalent organic group derived from a fused polycyclic heterocyclic compound having 2 to 10 of fused rings of five-membered rings and/or six-membered rings; R¹¹ represents a bivalent organic group; m is an integer of 0 to 10; and X³⁰ represents a halogen atom) with a compound represented by General Formula (γ):

X³¹—SiR¹²R¹³R¹⁴ (γ)

(wherein, X³¹ represents a hydrogen or halogen atom or an alkoxy group having 1 to 4 carbon atoms; and R¹² to R¹⁴ each independently represent a halogen atom or an alkoxy group having 1 to 4 carbon atoms) in Grignard reaction.

### EFFECTS OF THE INVENTION

The present invention provides a very highly stabilized and highly crystallized organic thin film, because the compounds represented by General Formulae (I) and (α) are chemically adsorbed on a substrate tightly by two-dimensional networking of the Si—O—Si groups formed intermolecularly between the compounds and the intermolecular interaction needed for crystallization of the film (tight packing force of the molecules) is generated efficiently. As a result, the thin film is adsorbed (fixed) on the surface of the substrate more tightly than the film prepared on a substrate by physical adsorption, and resistant to physical exfoliation. In addition, the compounds represented by General Formulae (I) and (α) are easy to be produced.

It is also possible to form a highly oriented (crystallized) crystalline organic thin film, because the network derived from the silyl group in the compound constituting the organic thin film are bound directly to the organic residues constituting an upper portion of the thin film and there are silyl group-derived network and intermolecular interaction between the π-conjugated molecule.

In addition, the compound represented by General Formula (I), which has at least one monocyclic heterocyclic unit containing a hetero atom selected from the group consisting of the elements in the 4A, 4B, 5B and 6B groups, in particular the group consisting of Si, Ge, Sn, P, Se, Te, Ti and Zr, has a stabilized LUMO, i.e., an electronic structure permitting easier electron transfer. As a result, the carriers transferred smoothly by hopping conduction among the compound molecules. Further, the compound has high electrically conductivity in the molecular-axis direction and thus, may be used not only as organic thin-film transistor material but also in a variety of applications such as solar battery, fuel cell, and sensor as an electrically conductive material.

Alternatively, the organic silane compound represented by General Formula (α), which has a skeleton of fused polycyclic heterocyclic compound, has a stabilized LUMO. Accordingly, it may be used as an N-type semiconductor material. Although there are many studies on P-type semiconductor materials, there is almost no studies on N-type semiconductor materials such as those in the present invention. The organic silane compound represented by General Formula (α) is very useful not only as an organic thin film transistor material, but also in organic devices such as solar battery, fuel cell, and sensor.

### BRIEF DESCRIPTION OF DRAWINGS

FIG. 1 is a schematic diagram chart illustrating the molecular orientation on an organic thin film.

FIG. 2 is a schematic chart showing the relationship between intermolecular distance and intermolecular force.

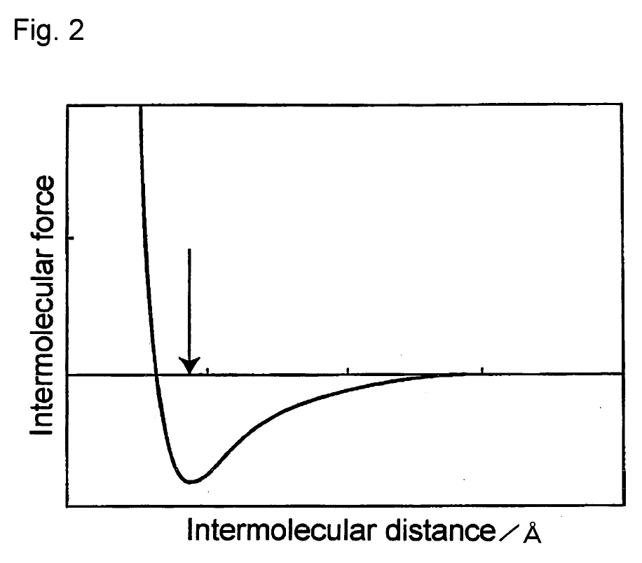

### BEST MODE FOR CARRYING OUT THE INVENTION

The π-electron-conjugated organic silane compound according to the present invention is a compound represented by General Formula (I) or (α). Hereinafter, the π-electron-conjugated organic silane compound (I) represented by General Formula (I) and the production method thereof, and the π-electron-conjugated organic silane compound (α) represented by General Formula (α) and the production method thereof will be describe in the order.

(Organic Silane Compound (I))

The π-electron-conjugated organic silane compound (I) according to the present invention is a compound represented by General Formula (I):

R¹—SiX¹X²X³ (I)

Hereinafter, the compound will be referred to as an organic silane compound (I).

In Formula (I) R¹ represents an organic group that may be substituted, having a monocyclic heterocyclic unit containing an atom selected from the group consisting of the elements in the 4A, 4B, 5B and 6B groups of the long-form periodic table. The monocyclic heterocyclic ring containing such an atom has a lower LUMO energy level, because there is σ*-π* conjugation between the σ* orbital of the atom site and the π* orbital of the double bond site in the heterocyclic ring, in particular the diene site therein, which apparently leads to distinct improvement in the electroconductive property (semiconductive property) of the compound. On the other hand, compounds only containing elements such as S, N, O, and C seemingly cannot give rise to such σ*-π* conjugation, and thus, have an unstabilized LUMO and consequently, relatively lower electroconductive property (semiconductive property).

The monocyclic heterocyclic ring contains at least one atom, preferably one or two atoms as atom constituting a ring, selected from the group consisting of the elements in the 4A, 4B, 5B and 6B groups of the long-form periodic table (hereinafter, referred to as Y₀ atom). The Y₀ atom is, for example, an atom selected from the group consisting of Si, Ge, Sn, P, Se, Te, Ti and Zr.

The monocyclic heterocyclic ring containing the Y₀ atom is preferably a five- to twelve-membered ring, more preferably a five- or six-membered ring.

Typical favorable examples of the monocyclic five-membered heterocyclic units include the following units:

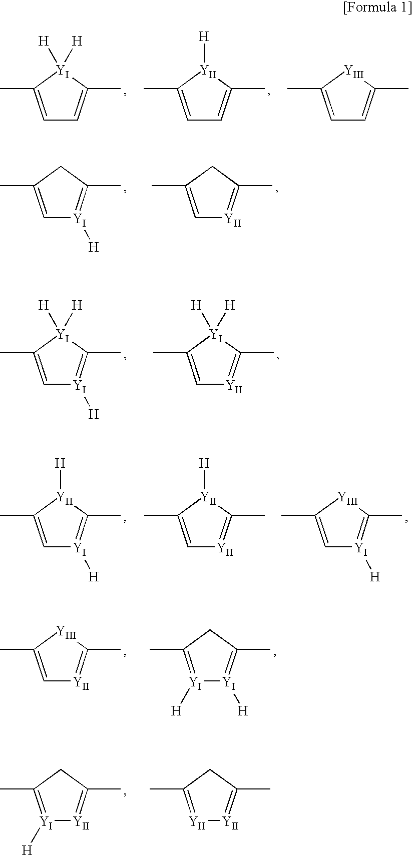

In the typical examples above, Y_{I} is in common an atom represented by an element in the 4A or 4B group such as Si, Ge, Sn, Ti or Zr.

Y_{II} is in common an atom represented by an element in the 5B group, such as P.

Y_{III} is in common an atom represented by an element in the 6B group such as Se or Te.

When one unit contains two or more pieces of a kind of Y group selected from Y_{I}, Y_{II} and Y_{III}, each of the Y group is selected independently in the range above.

Typical favorable examples of the monocyclic six-membered heterocyclic units include the following units:

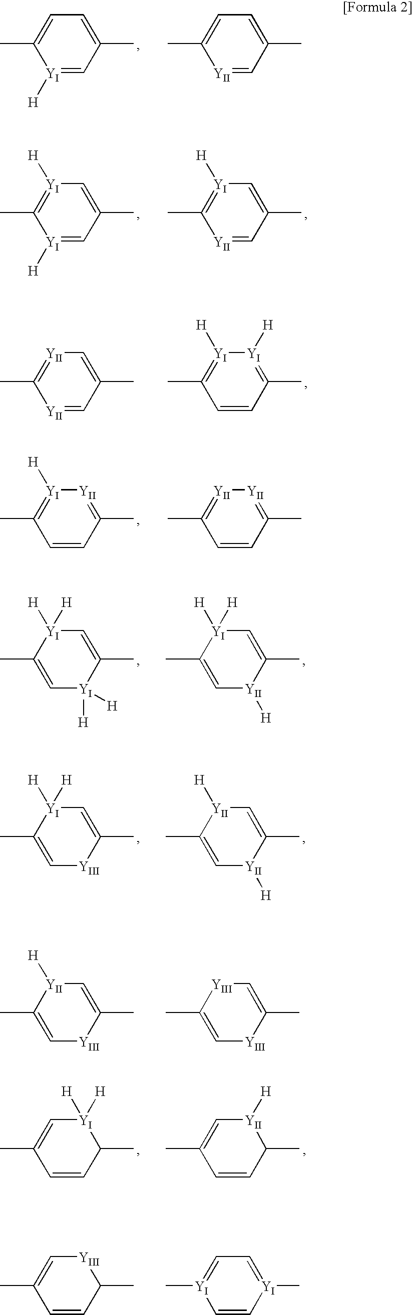

In the typical examples, Y_{I}, Y_{II} and Y_{III} are the same as those in the monocyclic five-membered heterocyclic unit.

Among the typical examples of the monocyclic five- and six-membered heterocyclic units, those having no bilateral symmetry include their mirror-image isomers.

One or more, for example 1 to 30, monocyclic heterocyclic units containing the Y₀ atom may be present in one R¹. In particular, R¹ preferably contains 1 to 9 of monocyclic heterocyclic units containing the Y₀ atom, from the viewpoint of yield, cost, and mass production.

When R¹ contains multiple Y₀ atom-containing monocyclic heterocyclic units, these units may be the same as each other, or part or all of the units may be different from each other.

R¹ may contain the other π-electron-conjugated monocyclic heterocyclic unit or/and a monocyclic aromatic hydrocarbon ring unit additionally.

Examples of the hetero atoms contained in the other monocyclic heterocyclic unit include oxygen, nitrogen and sulfur atoms. Typical examples of the other monocyclic heterocyclic units contained in R¹ include oxygen atom-containing heterocyclic ring such as furan; nitrogen atom-containing heterocyclic rings such as pyrrole, pyridine, pyrimidine, pyrroline, imidazoline and pyrazoline; sulfur atom-containing heterocyclic rings such as thiophene; nitrogen and oxygen atom-containing heterocyclic rings such as oxazole and isoxazole; sulfur and nitrogen atom-containing heterocyclic rings such as thiazole and isothiazole; and the like. Among them, thiophene is particularly preferable.

A typical example of the monocyclic aromatic hydrocarbon ring-unit contained in R¹ is a benzene ring.

When R¹ contains such other monocyclic heterocyclic unit or/and monocyclic aromatic hydrocarbon ring unit, the total number of the units and the monocyclic heterocyclic units containing the Y₀ atom is preferably in the range of the number of the Y₀ atom-containing monocyclic heterocyclic units described above.

When R¹ contains multiple other monocyclic heterocyclic units, these units may be the same as each other, or part or all of them may be different from each other. The same is true when R¹ contains multiple monocyclic aromatic hydrocarbon ring units.

When R¹ contains multiple pieces of the Y₀ atom-containing monocyclic heterocyclic unit, the other monocyclic heterocyclic units and the monocyclic aromatic hydrocarbon ring units, these units may be connected to each other linearly or in a branched manner. Branched connection means that at least one unit serves as a node to which two or more units are connected. Linear connection is preferable, from the viewpoint of the crystallinity (orientation) of organic thin film.

When R¹ contains multiple kinds of units, the multiple kinds of units may be connected to each other in a configuration having an ordered recurring unit or in a configuration where the units are randomly arranged.

Independently on whether the unit constituting R¹ is a Y₀ atom-containing monocyclic heterocyclic unit, the other monocyclic heterocyclic unit, or a monocyclic aromatic hydrocarbon ring unit, the binding sites of the unit may be any one of 2,5-, 3,4-, 2,3-, and 2,4-positions, preferably 2,5-positions, when the unit is a five-membered ring. In such a case, the binding sites of the Y₀ atom-containing monocyclic heterocyclic unit, in particular, may be 1,1-positions, in addition to the binding sites above. When the unit is a six-membered ring, the binding sites may be any one of 1,4-, 1,2-, 1,3-, 2,3-, 2,4-, and 2,5-positions, and are preferably 2,5-positions. The values of the binding sites above are the values relative to the hetero atom when the ring contains one hetero atom, relative to the hetero atom with the greatest atomic weight when the ring has two or more hetero atoms, and relative to any optional carbon atom when the ring has no hetero atom.

When R¹ contains multiple units, these units may be connected to each other directly or indirectly via a connecting group such as vinylene group. The vinylene group is a bivalent unsaturated organic group of the following hydrocarbons from which the hydrogen atoms at both terminals are eliminated. Examples of the hydrocarbons providing the vinylene group include alkenes, alkadienes, alkatrienes, and the like. Examples of the alkenes include compounds having 2 to 4 carbon atoms such as ethylene, propylene, and butylene, and among them, ethylene is preferable. Examples of the alkadienes include compounds having 4 to 6 carbon atoms such as butadiene, pentadiene, hexadiene, and the like. Examples of the alkatrienes include compounds having 6 to 8 carbon atoms such as hexatriene, heptatriene, octatriene, and the like.

Examples of the substituent groups possibly introduced on R¹ include a hydroxyl group, substituted and unsubstituted amino groups, a nitro group, a cyano group, substituted and unsubstituted alkyl groups, substituted and unsubstituted alkenyl groups, substituted and unsubstituted cycloalkyl groups, substituted and unsubstituted alkoxy groups, substituted and unsubstituted aromatic hydrocarbon groups, substituted and unsubstituted heterocyclic aromatic groups, substituted and unsubstituted aralkyl groups, substituted and unsubstituted aryloxy groups, substituted and unsubstituted alkoxycarbonyl groups, a carboxyl group, ester groups, and the like. Among these substituent groups, a group that does not inhibit crystallization of the organic thin film by steric hindrance is preferable, and a straight-chain alkyl group having 1 to 30 carbon atoms, in particular 1 to 4 carbon atoms is more preferable.

In Formula (I), X¹ to X³ each represent a group giving a hydroxyl group by hydrolysis. The group giving a hydroxyl group by hydrolysis is not particularly limited and may be, for example, a halogen atom, a lower alkoxy group, or the like. Examples of the halogen atoms include fluorine, chlorine, iodine, and bromine. Examples of the lower alkoxy groups include alkoxy groups having 1 to 4 carbon atoms such as methoxy, ethoxy, n-propoxy, 2-propoxy, n-butoxy, sec-butoxy, and tert-butoxy, and part of the group may be substituted with another functional group (e.g., trialkylsilyl and other alkoxy groups) additionally. X¹, X² and X³ may be the same as each other, and part or all of them may be different from each other, but all of them are preferably the same.

Typical favorable examples of the organic silane compounds (I) above include the compounds represented by the following General Formulae (1) to (11).

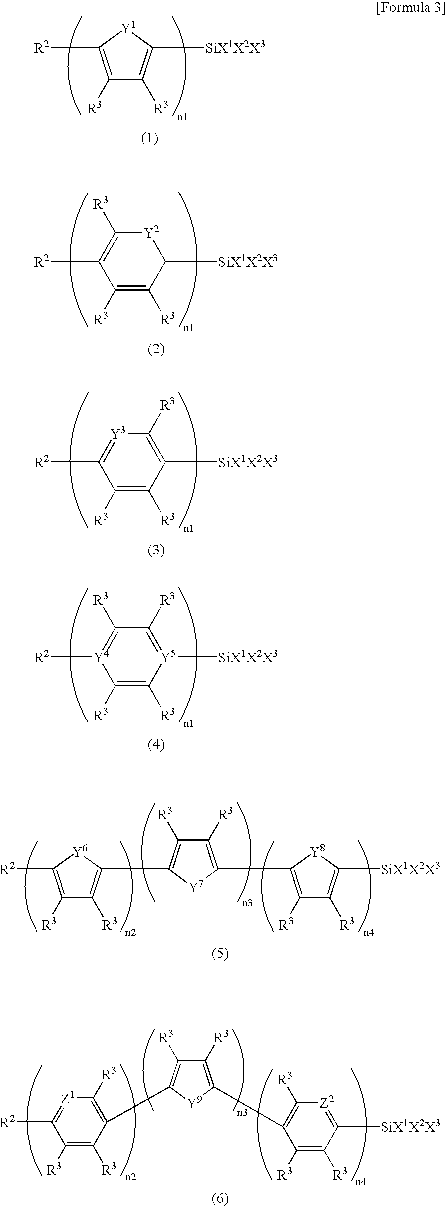

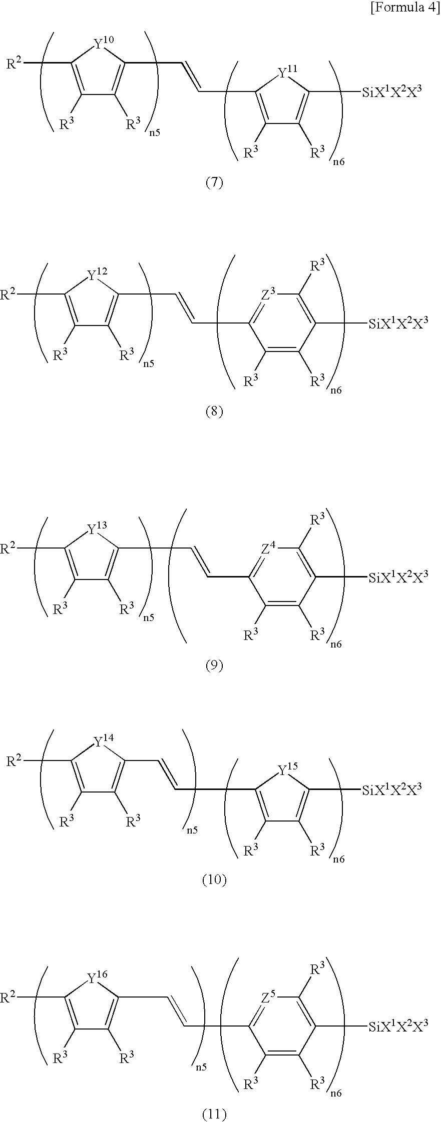

The groups and codes common in General Formulae (1) to (11) shown below are the same as each other.

Each of R² to R⁴ may be any group independently, if it is included in the range of the “substituent groups possibly introduced on R¹”, but is particularly preferably a hydrogen atom, a hydrocarbon group having 1 to 4 carbon atoms, a cycloalkyl group having 5 to 12 carbon atoms, or an aryl group having 6 to 18 carbon atoms.

When there are multiple groups R³ in each General Formula, each of the groups R³ is selected independently in the range above.

X¹ to X³ are the same as those shown in Formula (I), and each of them represents independently a fluorine, chlorine, iodine, or bromine atom, or a methoxy, ethoxy, n-propoxy, 2-propoxy, n-butoxy, sec-butoxy or tert-butoxy group. It is preferably a chlorine atom or a methoxy or ethoxy group.

The other groups and codes will be described below in each Formula separately.

In General Formula (I), Y¹ represents Si, Ge, Se, Te, P, Sn, Ti or Zr, preferably Si or Se. Specifically, when Y¹ is Si, Ge, Sn, Ti, or Zr, it is —Y¹(R⁴)₂—; when Y¹ is P, it is —Y¹(R⁴)—; and when Y¹ is Se or Te, it is —Y¹—. R⁴ is a hydrogen atom or a methyl, ethyl, n-propyl, 2-propyl, n-butyl, sec-butyl, tert-butyl, or phenyl group, preferably a hydrogen atom or a methyl group. n1 is an integer of 1 to 9, preferably of 2 to 8.

In General Formula (2), Y² represents Se or Te. Specifically, when Y² is Se or Te, it is —Y²—.

n1 is an integer of 1 to 9, preferably of 2 to 8.

In General Formula (3), Y³ represents Si, Ge, P, Sn, Ti or Zr, preferably Si or P. Specifically, when Y³ is Si, Ge, Sn, Ti, or Zr, it is —Y³(R⁴)═, and when Y³ is P, it is —Y³═. However, R⁴ is the same as that in Formula (1) and preferably a hydrogen atom or a methyl group.

n1 is an integer of 1 to 9, preferably of 2 to 8.

In General Formula (4), Y⁴ and Y⁵ each independently represent Si, Ge, Sn, Ti or Zr, preferably Si.

n1 is an integer of 1 to 9, preferably of 2 to 8.

In General Formula (5), Y⁶ to Y⁸ each independently represent S, N, O, Si, Ge, Se, Te, P, Sn, Ti or Zr. At least one group of Y⁶ to Y⁸, preferably at least Y⁷, is Si, Ge, Se, Te, P, Sn, Ti or Zr. Specifically, when Y⁶ is Si, Ge, Sn, Ti, or Zr, it is —Y⁶ (R⁴)₂—, when Y⁶ is N or P, it is —Y⁶ (R⁴)—; and when Y⁶ is S, O, Se, or Te, it is —Y⁶—. However, R⁴ is the same as that in Formula (1) and preferably a hydrogen atom or a methyl group. Specifically, Y⁷ and Y⁸ are similar to the Y⁶ described above in detail.

n2+n3+n4 is an integer of 1 to 9, preferably of 5 to 9. However, n2 is 1 or more, preferably 2 or more; n3 is 1 or more; and n4 is 1 or more, preferably 2 or more.

In General Formula (6), Y⁹ represents Si, Ge, Se, Te, P, Sn, Ti or Zr. Specifically, when Y⁹ is Si, Ge, Sn, Ti, or Zr, it is —Y⁹(R⁴)₂—; when Y⁹ is P, it is —Y⁹(R⁴)—; and when Y⁹ is Se or Te, it is —Y⁹—. However, R⁴ is the same as that in Formula (1) and preferably a hydrogen atom or methyl group.

Z¹ and Z² each independently represent N, C, Si, Ge, P, Sn, Ti or Zr. Specifically, when Z¹ is C, Si, Ge, Sn, Ti, or Zr, it is -Z¹(R⁴)═, and when Z¹ is N or P, it is -Z¹=. However, R⁴ is the same as that in Formula (1) and preferably a hydrogen atom or methyl group. Details of Z² are the same as those of Z¹.

n2+n3+n4 is an integer of 1 to 9, preferably of 5 to 9. However, n2 is 1 or more, preferably 2 or more; n3 is 1 or more, preferably 2 or more; and n4 is 1 or more, preferably 2 or more.

In the General Formula (7), Y¹⁰ to Y¹¹ each independently represent S, N, O, Si, Ge, Se, Te, P, Sn, Ti or Zr. However, at least one group of Y¹⁰ to Y¹¹ represents Si, Ge, Se, Te, P, Sn, Ti or Zr. Specifically, when Y¹⁰ is Si, Ge, Sn, Ti, or Zr, it is —Y¹⁰ (R⁴)₂—; when Y¹⁰ is N or P, it is —Y¹⁰ (R⁴)—; and when Y¹⁰ is S, O, Se, or Te, it is —Y¹⁰—. However, R⁴ is the same as that in Formula (1) and preferably a hydrogen atom or methyl group. Details of Y¹¹ are the same as those of Y¹⁰.

n5+n6 is an integer of 1 to 9, preferably of 5 to 8. However, n5 is 0 or more, preferably 1 or more, and n6 is 0 or more, preferably 1 or more.

In General Formula (8), Y¹² represents Si, Ge, Se, Te, P, Sn, Ti or Zr. Specifically, when Y¹² is Si, Ge, Sn, Ti, or Zr, it is —Y¹²(R⁴)₂—; when Y¹² is P, it is —Y¹²(R⁴)—; and when Y¹² is Se or Te, it is —Y¹²—. However, R⁴ is the same as that in Formula (1) and preferably a hydrogen atom or methyl group.

Z³ represents N, C, Si, Ge, P, Sn, Ti or Zr. Specifically, when Z³ is C, Si, Ge, Sn, Ti, or Zr, it is -Z³(R⁴)═, and when Z³ is N or P, it is -Z³=. R⁴ is the same as that in Formula (1) and preferably a hydrogen atom or methyl group.

n5+n6 is an integer of 1 to 9, preferably of 5 to 8. However, n5 is 1 or more, preferably 2 or more, and n6 is 0 or more, preferably 1 or more.

In General Formula (9), Y¹³ represents Si, Ge, Se, Te, P, Sn, Ti or Zr. Specifically, when Y¹³ is Si, Ge, Sn, Ti, or Zr, it is —Y¹³(R⁴)₂—; when Y¹³ is P, it is —Y¹³(R⁴)—; and when Y¹³ is Se or Te, it is —Y¹³—. However, R⁴ is the same as that in Formula (1) and preferably a hydrogen atom or methyl group.

Z⁴ represents N, C, Si, Ge, P, Sn, Ti or Zr. Specifically, when Z⁴ is C, Si, Ge, Sn, Ti, or Zr, it is -Z⁴(R⁴)═, and, when Z⁴ is N or P, it is -Z⁴=. R⁴ is the same as that in Formula (1) and preferably a hydrogen atom or methyl group.

n5+n6 is an integer of 1 to 9, preferably of 5 to 8. However, n5 is 1 or more, preferably 2 or more, and n6 is 0 or more, preferably 1 or more.

In General Formula (10), Y¹⁴ to Y¹⁵ each independently represent S, N, O, Si, Ge, Se, Te, P, Sn, Ti or Zr. However, at least one group of Y¹⁴ to Y¹⁵ represents Si, Ge, Se, Te, P, Sn, Ti or Zr. Specifically, when Y¹⁴ is Si, Ge, Sn, Ti, or Zr, it is —Y¹⁴(R⁴)₂—; when Y¹⁴ is N or P, it is —Y¹⁴(R⁴)—; and when Y¹⁴ is S, O, Se, or Te, it is —Y¹⁴—. R⁴ is the same as that in Formula (1) and preferably a hydrogen atom or methyl group. Details of Y¹⁵ are the same as those of Y¹⁴.

n5+n6 is an integer of 1 to 9, preferably of 5 to 8. However, n5 is 0 or more, preferably 1 or more, and n6 is 0 or more, preferably 1 or more.

In General Formula (11), Y¹⁶ represents Si, Ge, Se, Te, P, Sn, Ti or Zr. Specifically, when Y¹⁶ is Si, Ge, Sn, Ti, or Zr, it is —Y¹⁶(R⁴)₂—; when Y¹⁶ is P, it is —Y¹⁶(R⁴)—; and when Y¹⁶ is Se or Te, it is —Y¹⁶—. However, R⁴ is the same as that in Formula (1) and preferably a hydrogen atom or methyl group.

Z⁵ represents N, C, Si, Ge, P, Sn, Ti or Zr. Specifically, when Z⁵ is C, Si, Ge, Sn, Ti, or Zr, it is -Z⁵(R⁴)═, and, when Z⁵ is N or P, it is -Z⁵=. However, R⁴ is the same as that in Formula (1) and preferably a hydrogen atom or methyl group.

n5+n6 is an integer of 1 to 9, preferably of 5 to 8. However, n5 is 1 or more, preferably 2 or more, and n6 is 0 or more, preferably 1 or more.

(Method of Producing Organic Silane Compound (I))

Hereinafter, the method of producing the organic silane compound (I) according to the present invention will be described.

The organic silane compound (I) according to the present invention is prepared by allowing a compound represented by General Formula (II):

R¹—Li (II)

(wherein, R¹ is the same as that in Formula (I)) to react with a compound represented by General Formula (III):

X⁴—SiX¹X²X³ (III)

(wherein, X¹, X² and X³ are the same as those in Formula (I) X⁴ represents a hydrogen atom, a halogen atom (e.g., fluorine, chlorine, iodine or bromine) or a lower alkoxy group (e.g., methoxy, ethoxy, n-propoxy, 2-propoxy, n-butoxy, sec-butoxy, or tert-butoxy)), or by allowing a compound represented by General Formula (IV):

R¹—MgX⁵ (IV)

(wherein, R¹ is the same as that in Formula (I); and X⁵ represents a halogen atom) to react with a compound represented by General Formula (III) in Grignard reaction.

The compound represented by General Formula (II) or (IV) can be prepared, for example, by allowing a compound represented by R¹H (wherein, R¹ is the same as that in Formula (I)) to react with an alkyllithium, or by allowing a compound represented by R¹X⁵ (wherein, R¹ is the same as that in Formula (I); X⁵ represents a halogen atom such as fluorine, chlorine, iodine or bromine) to react with an alkylmagnesium halide, metal magnesium, or the like.

Examples of the alkyllithiums used in the reaction include lower alkyllithiums (having about 1 to 4 carbon atoms) such as n-butyllithium, s-butyllithium, and t-butyllithium. The amount added is preferably 1 to 5 moles, more preferably 1 to 2 moles, with respect to 1 mole of the compound R¹H. The alkylmagnesium halide is, for example, ethylmagnesium bromide, methylmagnesium chloride, or the like. The amount used is preferably 1 to 10 moles, more preferably 1 to 4 moles, with respect to 1 mole of the raw material compound R¹X⁵.

The temperature during the reaction between the compound represented by General Formula (II) and the compound represented by General Formula (III) or between the compound represented by General Formula (IV) and the compound represented by General Formula (III) is preferably, for example, −100 to 150° C., more preferably −20 to 100° C. The reaction period is, for example, about 0.1 to 48 hours. The reaction is normally carried out in an organic solvent inert to the reaction. Examples of the organic solvents inert to the reaction include aliphatic or aromatic hydrocarbons such as hexane, pentane, benzene, and toluene, ether solvents such as diethylether, dipropylether, dioxane, and tetrahydrofuran (THF), and the like, and these solvents may be used alone or as a liquid mixture. Among them, diethylether and THF are favorable. Any catalyst may be used in the reaction. Any known catalyst, such as platinum catalyst, palladium catalyst, or nickel catalyst, may be used.

Hereinafter, the method of producing the compound R¹H for obtaining the compound represented by General Formula (II) will be described, with reference to the typical examples described below (synthetic routes 1 to 5). The compound R¹X⁵ for preparation of the compound represented by General Formula (IV) can be prepared by halogenating R¹H with a halogenating agent such as N-bromosuccinimide or N-chlorosuccinimide.

Compound represented by General Formula (1) with its silyl group substituted with H

Hereinafter, the method of producing a compound R¹H having a monocyclic heterocyclic unit containing Se or Si as the atom (Y₀ atom) selected from the group consisting of the elements in the 4A, 4B, 5B and 6B groups of the long-form periodic table (Y₀) will be described, but obviously, it is possible to produce a compound R¹H having a monocyclic heterocyclic unit containing other hetero atom such as Ge, Te, P, Sn, Ti, or Zr by a similar method.

A method of producing a precursor (R¹H) for the five-membered ring derived from selenophene ring is reported in “Polymer (2003, 44, 5597-5603)”, and the method described in the report may be used in the present invention.

Methods of producing the precursor (R¹H) derived from silole ring are reported in “Journal of Organometallic Chemistry (2002, 653, 223-228)”, “Journal of Organometallic Chemistry (1998, 559, 73-80)”, and “Coordination Chemistry Reviews (2003, 244, 1-44), and the methods described in the reports may be used in the present invention.

The number of the Y₀ atom-containing monocyclic heterocyclic units (such as selenophene and silole ring units) can be controlled by repeating operations of halogenating a particular site of Y₀ atom-containing monocyclic heterocyclic unit-containing compound used as the starting material and allowing the halogenated compound obtained to react with a Grignard reagent containing a Y₀ atom-containing monocyclic unit in Grignard reaction (see, for example, first to fourth reaction formulae in synthetic route 1; first to second reaction formulae in synthetic route 2; the following reaction formula A, and first reaction formula in synthetic route 3).

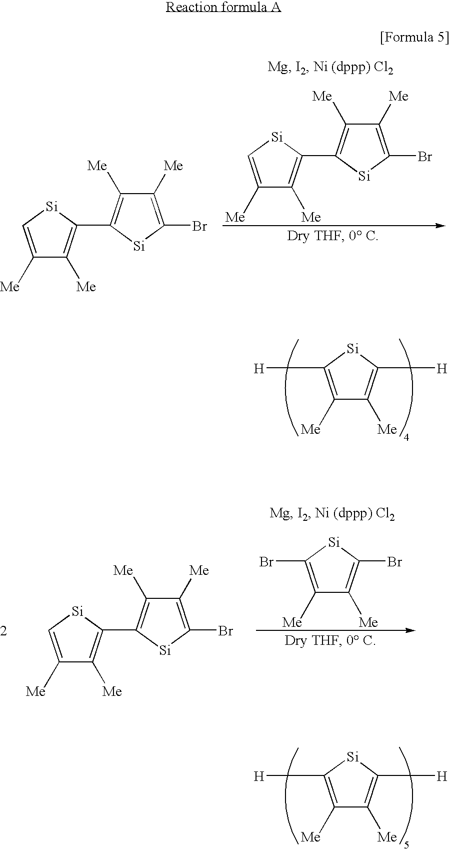

In the first to fourth reaction formula of synthetic route 1, a method of producing a precursor (R¹H) only of a selenophene ring and of producing a selenophene dimer or trimer from the monomer is shown. In the method, the number of selenophene rings is increased one by one, and thus, it is also possible to produce a precursor of tetramer or longer, similarly by repeating the reactions above.

In the first reaction formula of synthetic route 2, the reaction formula A above, and the first reaction formula of synthetic route 3, shown are methods of producing a precursor only of a silole ring and reaction of producing a silole dimer or tetramer to hexamer from the monomer or dimer. Also in these methods, the number of silole rings is increased one by one, and thus, it is also possible to produce a precursor of a trimer, heptamer or higher, similarly by repeating the reactions above.

In addition to the method of using the Grignard reagent, it is possible to produce R¹H while controlling the number of monocyclic heterocyclic units in R¹, by coupling in the presence of a suitable metal catalyst (Cu, Al, Zn, Zr, Sn, or the like).

Compound Represented by General Formula (5) or (6) with its Silyl Group Substituted with H

The block-type R¹H containing three kinds of R¹ block units can be prepared by connecting a compound containing the terminal block to both terminal of the compound containing the central block. Examples of the methods include Suzuki coupling, Grignard reaction, and the like.

For example, in connecting a thiophene- or benzene-derived unit respectively to both terminals of a compound having a silole ring (see first to third reaction formulae in synthetic route 4 and the first reaction formula in synthetic route 5), a compound having a silole ring is first debrominated and borated by addition of n-BuLi and B(O-iPr)₃. The solvent for use then is preferably ether. The boration reaction is a two-step process, and the first step is carried out at −78° C. for stabilization of the reaction in the early phase and the second step is carried out while the temperature is raised from −78° C. gradually to room temperature. Subsequently, a simple benzene or thiophene compound having a terminal halogen group (for example, bromine) and the borated compound above are allowed to react with each other, for example in toluene solvent in the presence of Pd (PPh₃)₄ and Na₂CO₃ at a reaction temperature of 85° C. until completion of the reaction, giving a coupling product between them. Although use of a compound having a silole ring is described, a monocyclic heterocyclic compound containing Ge, Se, Te, P, Sn, Ti, or Zr as the hetero atom also has a reactivity similar to that of silole at the 2,5-position. Thus, it is also possible to bind a thiophene- or benzene-derived unit to both terminals of a monocyclic heterocyclic compound containing Ge, Se, Te, P, Sn, Ti, or Zr as the hetero atom by a production method similar to that above. Although binding of a thiophene- or benzene-derived unit is describe above, the thiophene- or benzene-derived unit region may be replaced with a unit derived from a monocyclic heterocyclic compound containing Si, Ge, Se, Te, P, Sn, Ti, or Zr as the hetero atom.

In any synthetic method for the R¹H described above, it is possible to introduce a substituent group on R¹H, by using a raw material having a desirable substituent group (e.g., alkyl group) at a particular site. For example in synthetic route 1, it is possible to obtain 2-octadecylterselenophene by using 2-octadecylselenophene as the raw material (fourth reaction formula). Subsequent reaction with a silane compound represented by General Formula (III) gives an organic silane compound (I) having a desirable substituent at the particular site.

Typical examples of the methods of producing the organic silane compound (I) according to the present invention are shown in synthetic routes 1 to 5.

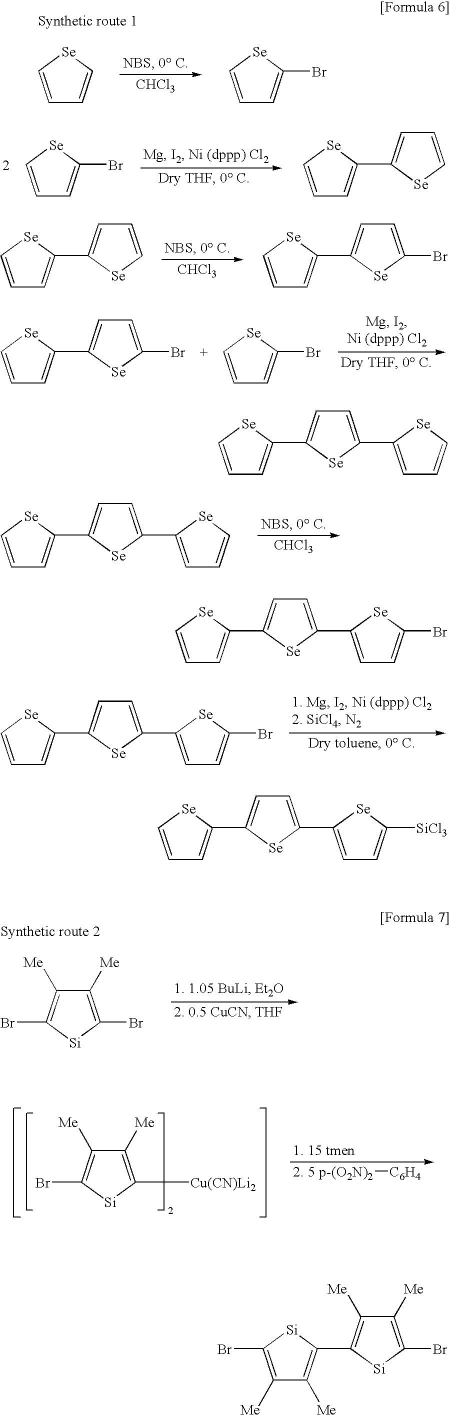

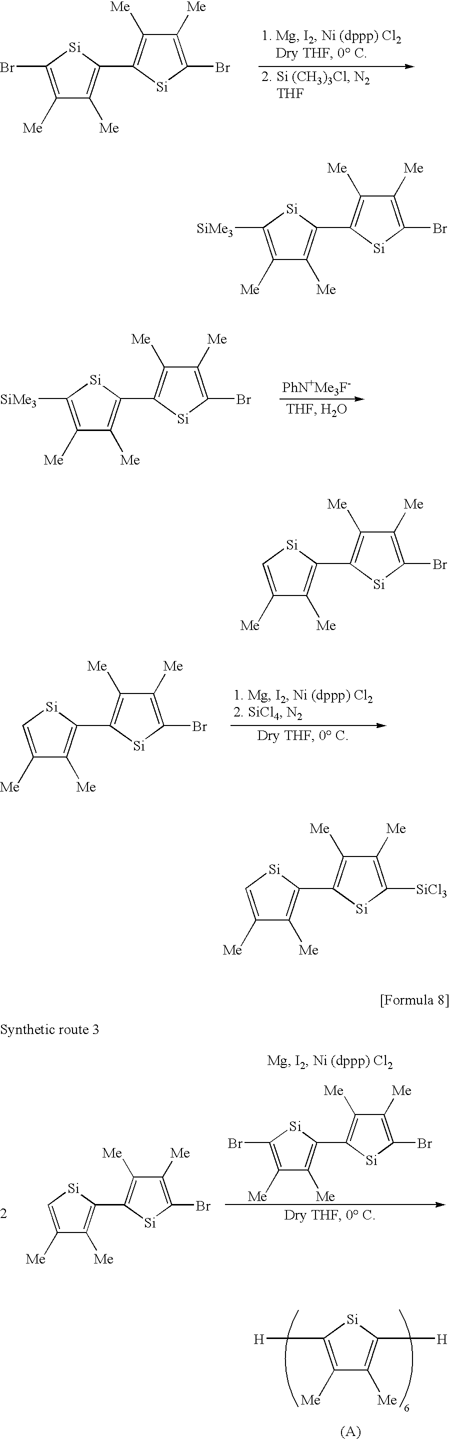

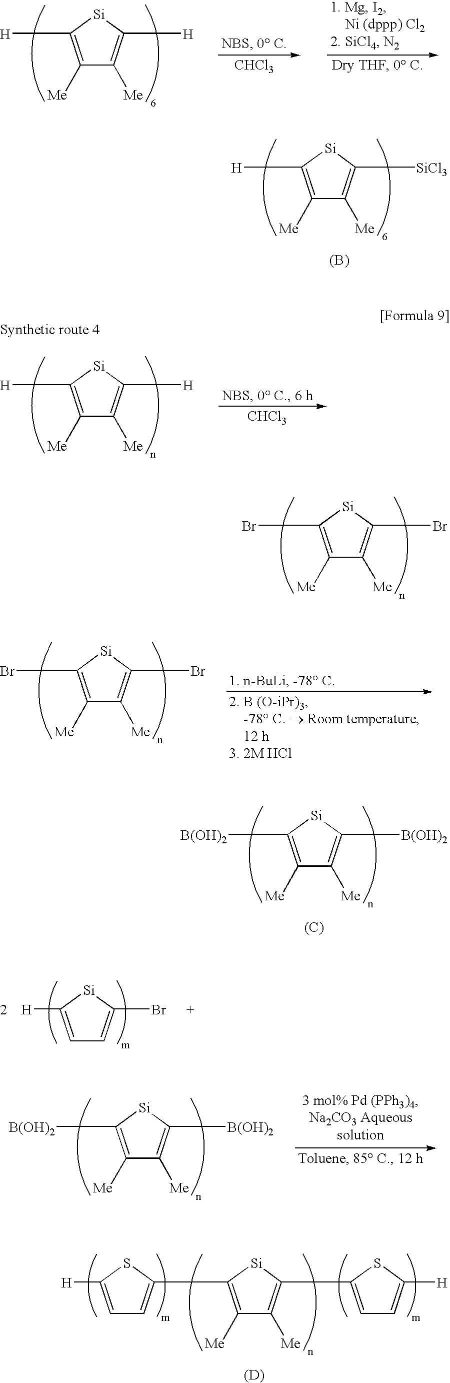

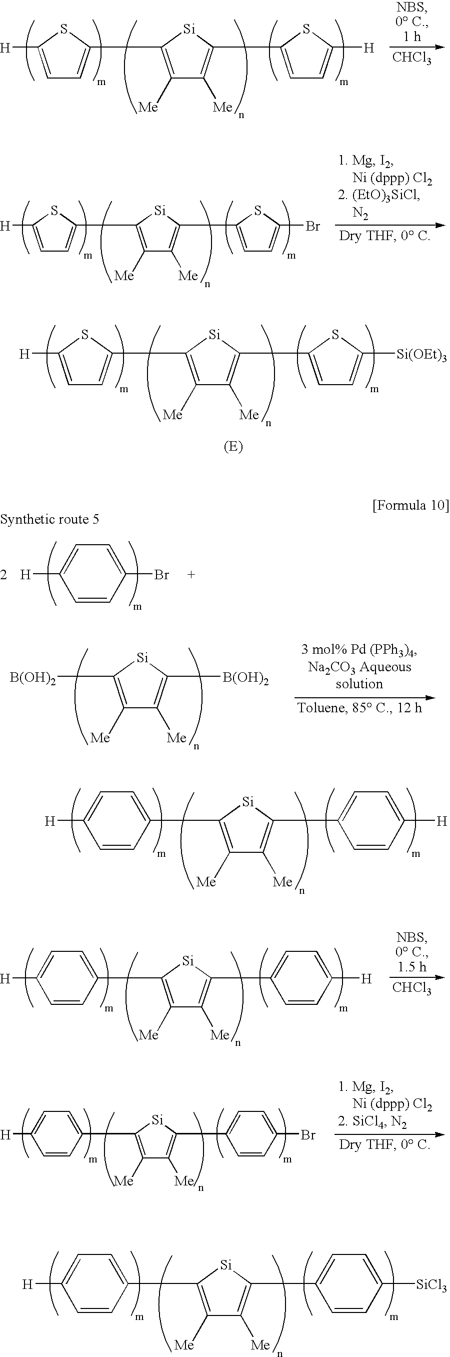

The organic silane compound (I) thus obtained may be isolated and purified from reaction solvent by any one of known means such as resolubilization, concentration, solvent extraction, fractionation, crystallization, recrystallization, chromatography, and the like.

(Organic Silane Compound (α))

The π-electron-conjugated organic silane compound (α) according to the present invention is a compound represented by General Formula (α):

Z-(R¹¹)ₘ—SiR¹²R¹³R¹⁴ (α)

Hereinafter, the compound will be referred to as an organic silane compound (α).

In Formula (α), Z is a monovalent organic group derived from a π-electron-conjugated fused polycyclic heterocyclic compound, i.e., a monovalent residue of a fused polycyclic heterocyclic compound of which a hydrogen atom is eliminated from any one of atoms constituting the ring. The term “π-electron conjugation” means delocalization of π-electrons of π bonds over the σ and π bonds in a compound.

The fused polycyclic heterocyclic compound for the organic group Z is constituted by a five-membered ring and/or a six-membered ring, and has at least one, preferably one or two, heterocyclic ring. Examples of the hetero atoms in the heterocyclic ring include silicon (Si), germanium (Ge), tin (Sn), titanium (Ti), zirconium (Zr), nitrogen (N), phosphorus (P), oxygen (O), sulfur (S), selenium (Se), and tellurium (Te) atoms. The hetero atom is preferably N, O, or S, considering the yield in production of the fused polycyclic heterocyclic compound.

The five- and six-membered rings for the fused polycyclic heterocyclic compound include the rings shown below. When the following rings form a fused polycyclic heterocyclic compound by fusion, normally two carbon atoms in a ring are possessed by another ring.

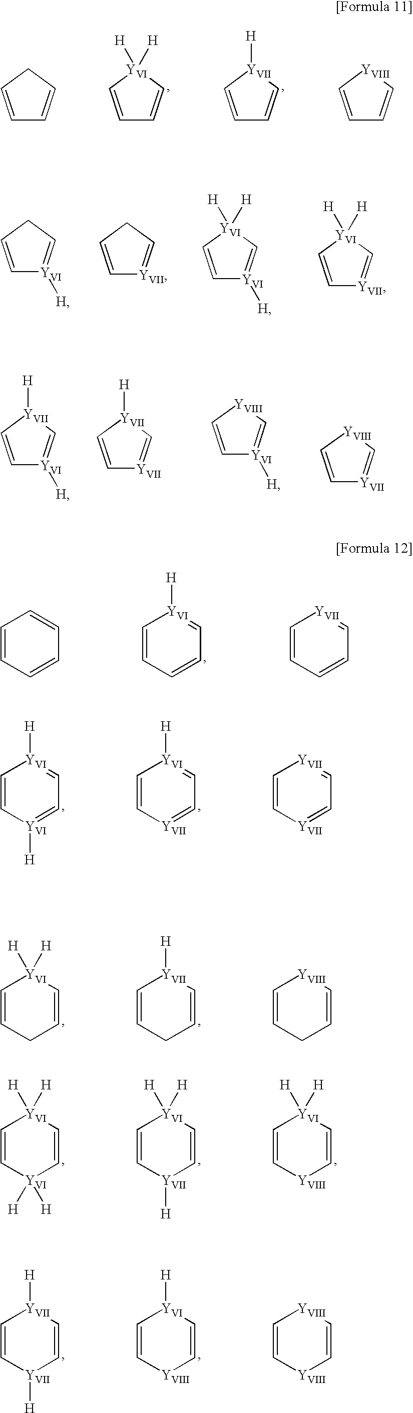

In all the typical examples above, Y_{VI} represents Si, Ge, Sn, Ti or Zr in common.

Y_{VII} represents N or P in common.

Y_{VIII} represents O, S, Se or Te in common.

The number of the fused rings constituting the fused polycyclic heterocyclic compound is 2 to 10, and the number of fused rings is preferably 2 to 5 from the viewpoint of yield. Typical examples of the organic group Z derived from the fused polycyclic heterocyclic compound include the following groups:

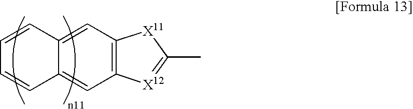

(wherein, X¹¹ represents C, N, O or S; X¹² represents C or N (however, X¹¹ and X¹² are not C at the same time); and n11 is an integer of 0 to 8).

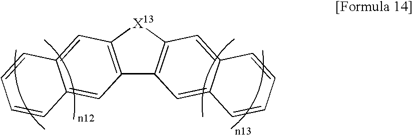

(wherein, X¹³ represents N, O or S; n12 and n13 are integers satisfying 0≦n12+n13≦7).

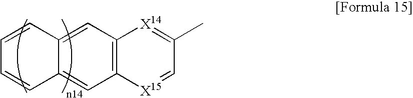

(wherein, X¹⁴ and X¹⁵ each independently represent C or N (however X¹⁴ and X¹⁵ are not C at the same time); and n14 is an integer of 0 to 8)

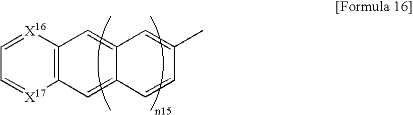

(wherein, X¹⁶ and X¹⁷ each independently represent C or N (however, X¹⁶ and X¹⁷ are not C at the same time); and n15 is an integer of 0 to 8).

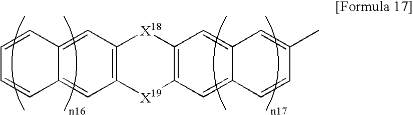

(wherein, X¹⁸ and X¹⁹ each independently represent C, N, O or S (however, X¹⁸ and X¹⁹ are not C at the same time); and n16 and n17 are integers satisfying 0≦n16+n17≦7).

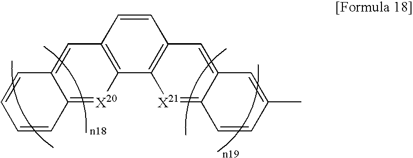

(wherein, X²⁰ and X²¹ each independently represent C or N (however, X²⁰ and X²¹ are not C at the same time); and n18 and n19 are integers satisfying 0≦n18+n19≦7).

The organic silane compound (α) may have a bivalent organic group between the organic group Z and the silyl group described below; and thus in Formula (α), R¹¹ represents a bivalent organic group; and m is an integer of 0 to 10.

The organic group R¹¹ is specifically a bivalent organic group derived from a π-electron conjugated molecule or a non-π-electron-conjugated molecule, i.e., a bivalent residue of a π-electron-conjugated molecule or non-π-electron-conjugated molecule from which two hydrogen atoms are eliminated or the composite group thereof.

Examples of the π-electron-conjugated molecule, from which the organic group R¹¹ is derived, include monocyclic aromatic hydrocarbon compounds, monocyclic heterocyclic compounds, fused polycyclic aromatic hydrocarbon compounds, and the like.

An example of the monocyclic aromatic hydrocarbon compound is benzene.

Examples of the hetero atoms contained in the monocyclic heterocyclic compound include N, O, S, Si, Ge, Se, Te, P, Sn, Ti, and Zr, and the like, and preferable are N, O, and S, from the viewpoint of production cost.

Favorable examples of the monocyclic heterocyclic compounds include furan, pyrrole, pyridine, pyrimidine, pyrroline, imidazoline, pyrazoline, thiophene, oxazole, isoxazole, thiazole, isothiazole, and the like.

The fused polycyclic aromatic hydrocarbon compound is a fused compound of two or more benzene rings, and is preferably symmetrical, in particular axisymmetric, from the viewpoint of electrical conductivity. Typical favorable examples of the compounds include the compound represented by the following General Formula:

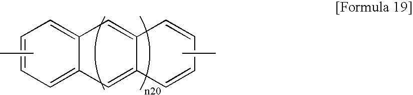

(wherein, n20 is an integer of 0 to 8), phenalene, perylene, coronene, and ovalene.

Examples of the fused polycyclic aromatic hydrocarbon compounds represented by General Formula above include naphthalene, anthracene, tetracene (naphthacene), pentacene, hexacene, heptacene, and octacene.

The non-π-electron-conjugated molecule from which the organic group R¹¹ is derived is, for example, a straight-chain saturated aliphatic hydrocarbon compound and the like. A group —(CH₂)ₘ— is derived from the straight-chain saturated aliphatic hydrocarbon compound.

When m is 2 or more, the multiple organic groups R¹¹ may be the same as each other, or part or all of them may be different from each other.

In Formula (α) above, the groups R¹² to R¹⁴ constituting the silyl group each independently represent a halogen atom or an alkoxy group having 1 to 4 carbon atoms. The alkoxy group is preferably a straight-chain group.

Typical examples of the alkoxy groups include methoxy, ethoxy, n-propoxy, 2-propoxy, n-butoxy, sec-butoxy, tert-butoxy, and the like. Part of the hydrogen atoms in the alkoxy group may be substituted with another substituent group such as a trialkylsilyl group (alkyl group having 1 to 4 carbon atoms) or an alkoxy group (having 1 to 4 carbon atoms).

Examples of the halogen atoms include fluorine, chlorine, iodine, bromine, and the like, and preferable from reactivity is a chlorine atom.

Preferably, R¹² to R¹⁴ each independently represent a chlorine atom or an alkoxy group having 1 to 2 carbon atoms.

Typical favorable examples of the organic silane compounds (α) include the organic silane compounds represented by General Formulae shown below.

(1) π-Electron-conjugated organic silane compounds represented by General Formula (αI):

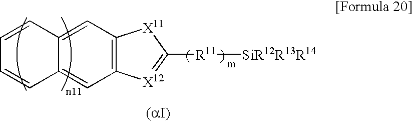

In General Formula (αI), X¹¹ represents C, N, O or S, preferably N, O or S, and more preferably N; specifically, when X¹¹ is C, it is —CH₂—, when X¹¹ is N, it is —NH—, and when X¹¹ is O or S, it is —X¹¹—; X¹² represents C or N, preferably N; specifically, when X¹² is C, it is —CH═, and, when X¹² is N, it is —N═; however, X¹¹ and X¹² are not C at the same time; and n11 is an integer of 0 to 8, preferably of 0 to 3.

In Formula (αI), R¹¹ to R¹⁴ and m are the same as those in Formula (α). Specifically, R¹¹ represents a bivalent organic group, i.e., a bivalent residue of the monocyclic aromatic hydrocarbon compound, monocyclic heterocyclic compound, fused polycyclic aromatic hydrocarbon compound, or saturated aliphatic hydrocarbon compound as described in General Formula (α) from which two hydrogen atoms are eliminated, or the composite group thereof. Preferably, it is a bivalent organic group selected from the group consisting of the groups represented by the following General Formulae (i) to (iv):

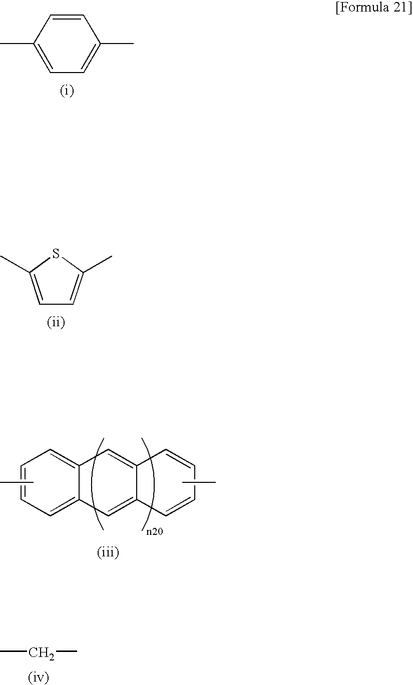

(wherein, n20 is an integer of 0 to 8, preferably 0 or 1). Examples of the most favorable R¹¹ are the groups represented by General Formulae (i) to (iii); when m described below is 2 or more, the multiple organic groups R¹ may be the same as each other, or part or all of them may be different from each other;

m is an integer of 0 to 10, preferably 0 to 7, and more preferably 0 to 3; and

R¹² to R¹⁴ each independently represent a halogen atom or an alkoxy group having 1 to 4 carbon atoms, preferably a chlorine atom or a methoxy or ethoxy group.

Other typical examples of the organic silane compounds represented by General Formula (αI) include the following compounds:

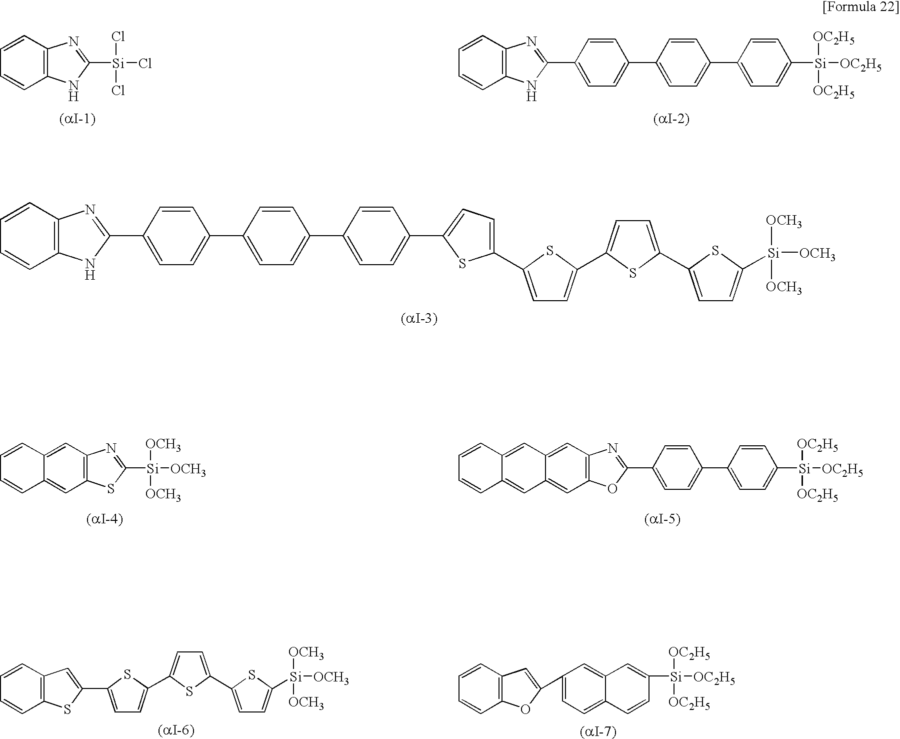

(2) π-Electron-conjugated organic silane compounds represented by General Formula (αII):

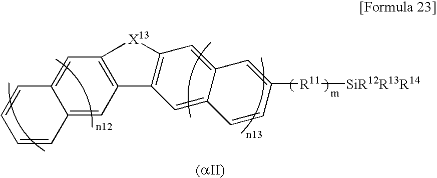

In General Formula (αII), X¹³ represents N, O or S, preferably N or O; specifically, when X¹³ is N, it is —NH—, and when X¹³ is O or S, it is —X¹³—; and n12 and n13 are integers satisfying 0≦n12+n13≦7, preferably 0≦n12+n13≦2.

In Formula (αII), R¹¹ to R¹⁴ and m are the same as those in Formula (α);

Specifically, R¹¹ represents a bivalent organic group, i.e., a bivalent residue of the monocyclic aromatic hydrocarbon compound, monocyclic heterocyclic compound, fused polycyclic aromatic hydrocarbon compound, or saturated aliphatic hydrocarbon compound as described in General Formula (α) from which two hydrogen atoms are eliminated, or the composite group thereof. Preferable is a bivalent organic group selected from the group consisting of the groups represented by General Formulae (i) to (iv) above (wherein, n20 is an integer of 0 to 8, preferably 0 or 1). Most preferable groups R¹¹ are the groups represented by General Formulae (i) and (iii); when m described below is 2 or more, the multiple organic groups R¹¹ may be the same as each other, or part or all of them may be different from each other;

m is an integer of 0 to 10, preferably 0 to 2, and more preferably 0 or 1;

R¹² to R¹⁴ each independently represent a halogen atom or an alkoxy group having 1 to 4 carbon atoms, preferably a chlorine atom or a methoxy or ethoxy group.

Other typical examples of the organic silane compounds represented by General Formula (αII) include the following compounds:

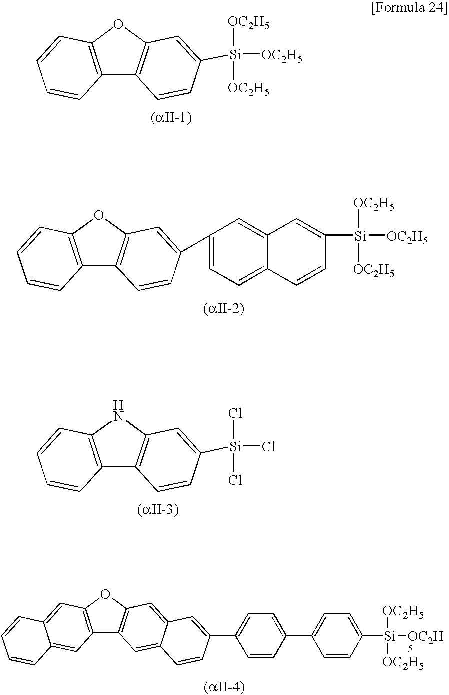

(3) π-Electron-conjugated organic silane compounds represented by General Formula (αIII):

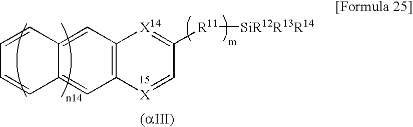

In General Formula (αIII), X¹⁴ and X¹⁵ each independently represent C or N; preferably X¹⁴ is N and X¹⁵ is C; specifically, when X¹⁴ is C, it is —CH═, when X¹⁴ is N, it is —N═, and when X¹⁵ is C, it is —CH═, when X¹⁵ is N, it is —N═:

however, X¹⁴ and X¹⁵ are not C at the same time; and

n14 is an integer of 0 to 8, preferably 0 to 3, more preferably 0 or 1.

In Formula (αIII), R¹¹ to R¹⁴ and m are the same as those in Formula (α).

Specifically, R¹¹ represents a bivalent organic group, i.e., a bivalent residue of the monocyclic aromatic hydrocarbon compound, monocyclic heterocyclic compound, fused polycyclic aromatic hydrocarbon compound, or saturated aliphatic hydrocarbon compound as described in General Formula (α) from which two hydrogen atoms are eliminated, or the composite group thereof. Preferable is a bivalent organic group selected from the group consisting of the groups represented by the General Formulae (i) to (iv) (wherein, n20 is an integer of 0 to 8, preferably 0 or 1). The most preferable groups R¹¹ are the groups represented by General Formulae (ii) and (iii); when m described below is 2 or more, the multiple organic groups R¹¹ may be the same as each other, or part or all of them may be different from each other;

m is an integer of 0 to 10, preferably 0 to 2, and more preferably 0 or 1; and

R¹² to R¹⁴ each independently represent a halogen atom or an alkoxy group having 1 to 4 carbon atoms, preferably a chlorine atom or a methoxy or ethoxy group.

Other typical examples of the organic silane compounds represented by General Formula (αIII) include the following compounds:

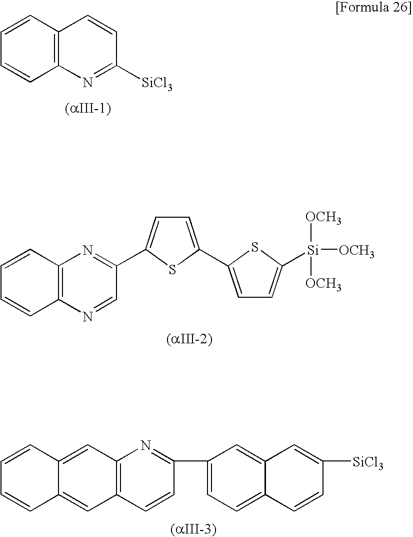

(4) π-Electron-conjugated organic silane compounds represented by General Formula (αIV):

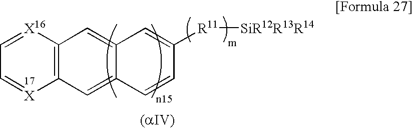

In General Formula (αIV), X¹⁶ and X¹⁷ each independently represent C or N, and preferably, X¹⁶ and X¹⁷ are N at the same time; specifically, when X¹⁶ is C, it is —CH═, and when X¹⁶ is N, it is —N═; when X¹⁷ is C, it is —CH═, and when X¹⁷ is N, it is —N═:

however, X¹⁶ and X¹⁷ are not C at the same time; and

n15 is an integer of 0 to 8, preferably 0 to 3, and more preferably 0 or 1.

In Formula (αIV), R¹ to R¹⁴ and m are the same as those in Formula (α).

Specifically, R¹¹ represents a bivalent organic group, i.e., a bivalent residue of the monocyclic aromatic hydrocarbon compound, monocyclic heterocyclic compound, fused polycyclic aromatic hydrocarbon compound, or saturated aliphatic hydrocarbon compound as described in General Formula (α) from which two hydrogen atoms are eliminated, or the composite group thereof. Preferable is a bivalent organic group selected from the group consisting of the groups represented by General Formulae (i) to (iv) (wherein, n20 is an integer of 0 to 8, preferably 0 to 3). The most preferable groups R¹¹ are the groups represented by General Formula (i); when m described below is 2 or more, the multiple organic groups R¹¹ may be the same as each other, or part or all of them may be different from each other;

m is an integer of 0 to 10, preferably 0 to 3; and

R¹² to R¹⁴ each independently represent a halogen atom or an alkoxy group having 1 to 4 carbon atoms, preferably a chlorine atom or a methoxy or ethoxy group.

In General Formula (αIV), when m is 0, the fused benzene or heterocyclic ring may have a hydrophobic group such as an alkyl group having 1 to 30 carbon atoms.

Other typical examples of the organic silane compounds represented by General Formula (αIV) include the following compounds:

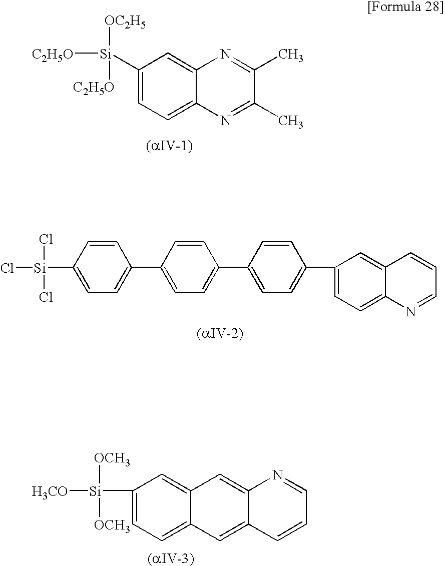

(5) π-Electron-conjugated organic silane compounds represented by General Formula (αV):

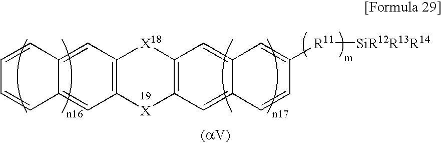

In General Formula (αV), X¹⁸ and X¹⁹ each independently represent C, N, O or S; the combination of X¹⁸ and X¹⁹ is preferably N—S, N—O, S—O, N—N or C—N, more preferably N—S; specifically, when X¹⁸ is C, it is —CH₂—, when X¹⁸ is N, it is —NH—, and when X¹⁸ is O or S, it is —X¹⁸—; when X¹⁹ is C, it is —CH₂—, when X¹⁹ is N, it is —NH—, and when X¹⁹ is O or S, it is —X¹⁹—;

however, X¹⁸ and X¹⁹ are not C at the same time; and

n16 and n17 are integers satisfying 0≦n16+n17≦7, preferably 0≦n16+n17≦2.

In Formula (αV), R¹¹ to R¹⁴ and m are the same as those in Formula (α).

Specifically, R¹¹ represents a bivalent organic group, i.e., a bivalent residue of the monocyclic aromatic hydrocarbon compound, monocyclic heterocyclic compound, fused polycyclic aromatic hydrocarbon compound, or saturated aliphatic hydrocarbon compound as described in General Formula (α) from which two hydrogen atoms are eliminated, or the composite group thereof. Preferable is a bivalent organic group selected from the group consisting of the groups represented by General Formulae (i) to (iv) (wherein, n20 is an integer of 0 to 8, preferably 0 to 3). The most preferable groups R¹¹ are the groups represented by General Formulae (i) to (iii); when m described below is 2 or more, the multiple organic groups R¹¹ may be the same as each other, or part or all of them may be different from each other;

m is an integer of 0 to 10, preferably 0 to 4; and

R¹² to R¹⁴ each independently represent a halogen atom or an alkoxy group having 1 to 4 carbon atoms, preferably a chlorine atom or a methoxy or ethoxy group.

Other typical examples of the organic silane compounds represented by General Formula (αV) include the following compounds:

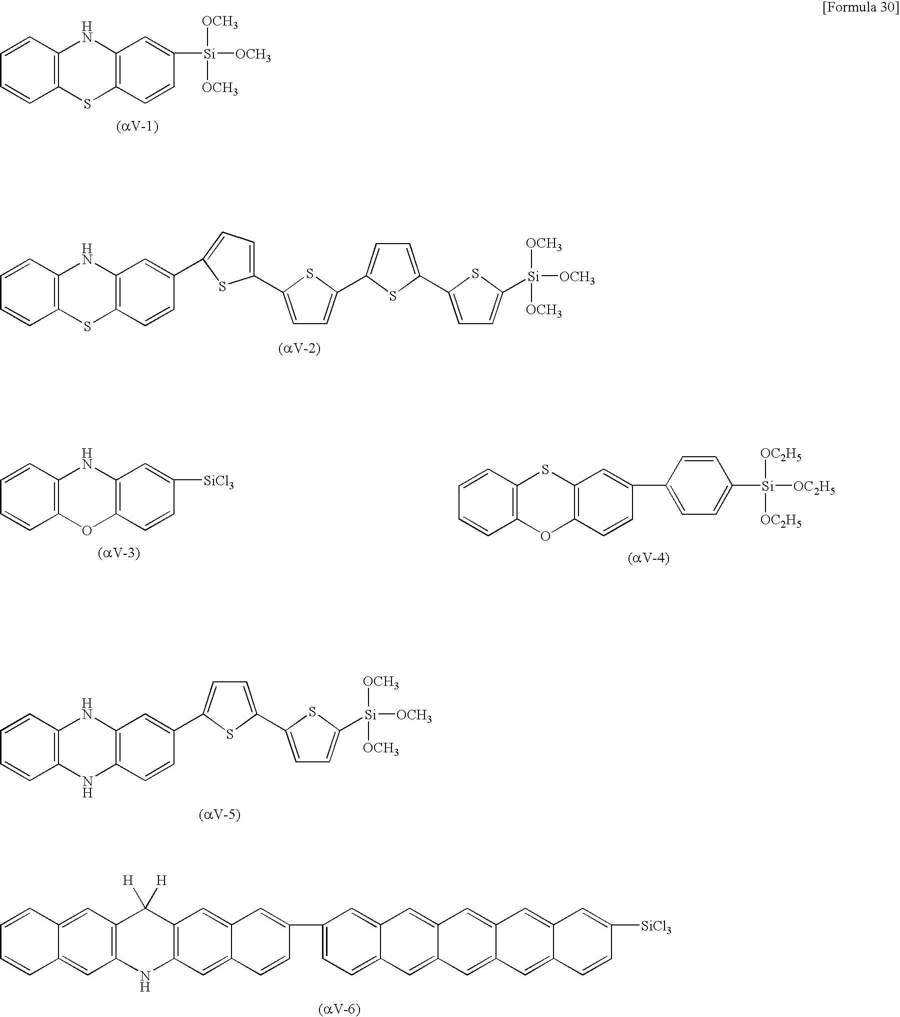

(6) π-Electron-conjugated organic silane compounds represented by General Formula (αVI);

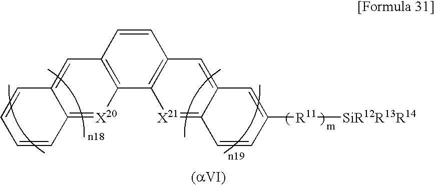

In General Formula (αVI), X²⁰ and X²¹ each independently represent C or N, preferably N at the same time; specifically, when X²⁰ is C, it is —CH═, when X²¹ is N, it is —N═; when X²¹ is C, it is —CH═, and when X²¹ is N, it is —N═;

however, X²⁰ and X²¹ are not C at the same time; and

n18 and n19 are integers satisfying 0≦n18+n19≦7, preferably 0≦n18+n19≦2.

In Formula (αVI), R¹¹ to R¹⁴ and m are the same as those in Formula (α).

Specifically, R¹¹ is a bivalent organic group, i.e., a bivalent residue of the monocyclic aromatic hydrocarbon compound, monocyclic heterocyclic compound, fused polycyclic aromatic hydrocarbon compound, or saturated aliphatic hydrocarbon compound as described in General Formula (α) from which two hydrogen atoms are eliminated, or the composite group thereof. Preferable is ambivalent organic group selected from the group consisting of the groups represented by General Formulae (i) to (iv) above (wherein n20 is an integer of 0 to 8, preferably 0 to 3). The most preferable group R¹¹ is a group represented by General Formula (iii) above; when m described below is 2 or more, the multiple organic groups R¹¹ may be the same as each other, or part or all of them may be different from each other;

m is an integer of 0 to 10, preferably of 0 to 2; and

R¹² to R¹⁴ each independently represent a halogen atom or an alkoxy group having 1 to 4 carbon atoms, preferably a chlorine atom or a methoxy or ethoxy group.

In General Formula (αVI), when m is 0, the fused benzene ring or the heterocyclic ring may have a hydrophobic group such as an alkyl group having 1 to 30 carbon atoms.

Other typical examples of the organic silane compounds represented by General Formula (αVI) include the following compounds:

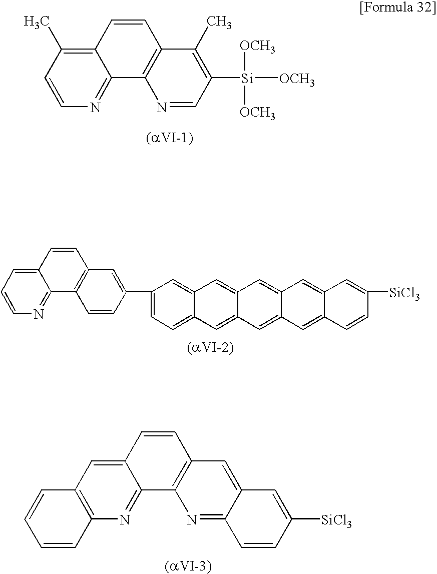

(Method of Preparing Organic Silane Compound (α))

The organic compound (α) according to the present invention can be prepared by allowing a compound represented by General Formula (β):

Z-(R¹¹)ₘ—MgX³⁰ (β)

(wherein, Z, R¹¹ and m are respectively the same as those in General Formula (α); and X³⁰ represents a halogen atom) to react with a compound represented by General Formula (γ):

X³¹—SiR¹²R¹³R¹⁴ (γ)

(wherein, X³¹ represents a hydrogen or halogen atom or an alkoxy group having 1 to 4 carbon atoms; and R¹² to R¹⁴ each independently represent a halogen atom or an alkoxy group having-1 to 4 carbon atoms) in Grignard reaction. The organic silane compounds represented by General Formulae (αI) to (αVI) can also be prepared according to the method.

The reaction temperature is preferably, for example, −100 to 150° C., more preferably −20 to 100° C. The reaction period is, for example, about 0.1 to 48 hours. The reaction is normally carried out in an organic solvent inert to the reaction. Examples of the organic solvents inert to the reaction include aliphatic or aromatic hydrocarbons such as hexane, pentane, benzene, and toluene; ether solvents such as diethylether, dipropylether, dioxane, and tetrahydrofuran (THF); and the like, and these solvents may be used alone or as a liquid mixture. Among them, diethylether and THF are favorable. A catalyst may be used as needed in the reaction. The catalyst for use may be any catalyst such as platinum catalyst, palladium catalyst, or nickel catalyst.

The organic silane compound (α) according to the present invention thus prepared by the method above may be isolated and purified from the reaction solution by any one of known means such as resolubilization, concentration, solvent extraction, fractionation, crystallization, recrystallization, chromatography, or the like.

The compound represented by General Formula (β) (hereinafter, referred to as compound (β); Grignard reagent) can be prepared by allowing a compound represented by General Formula (β-1);

Z-(R¹¹)ₘ—X³⁰ (β-1)

(wherein, Z, R¹¹, m and X³⁰ are respectively the same as those in General Formula (β)) (hereinafter, referred to as compound (β-1) to react with a metal magnesium in an organic solvent similar to that above.

When m is 0, the compound (β-1) can be prepared by halogenating a compound represented by General Formula (β-2) or (β-3):

Z-H (β-2)

Z-OH (β-3)

(wherein, Z is, in common, the same as that in General Formula (β)) (hereinafter, respectively referred to as compound (β-2) or (β-3)) at a particular site in a solvent such as carbon tetrachloride by using N-chlorosuccinimide (NCS), N-bromosuccinimide (NBS), or the like.

The compound (β-1) when m is 0 is commercially available.

For example, 2-chlorobenzimidazole (CAS. No. 7228-38-8), 2-chlorophenothiazine (CAS. No. 92-39-7), and 2-chloroquinoline (CAS. No. 612-62-4) are commercially available respectively, for example, from Sigma Aldrich Corporation.

The compounds (β-2) and (β-3) are also generally commercially available.

For example, 4,7-Dimethyl-1,10-phenanthroline (CAS. No. 3248-05-3), 2-hydroxydibenzofuran (CAS. No. 86-77-1), 2-hydroxycarbazole (CAS. No. 86-79-3), and 2,3-dimethylquinoxaline (CAS. No. 2379-55-7) are commercially available respectively from Sigma Aldrich Corporation.

The compound (β-1) when m is 1 or more is produced by preparing a Grignard reagent of the compound (β-2) or a compound represented by General Formula (β-4):

H—(R¹¹)ₘ—H (β-4)

(wherein, R¹¹ and m are respectively the same as those in General Formula (β)) (hereinafter, referred to as compound (β-4)) and allowing the Grignard reagent to react with the halide of the other compound.

In particular when a Grignard reagent is formed with a compound (β-4), it is generally prepared by dihalogenating the compound at both terminals and allowing metal, such as magnesium, to react with only one halogen atom at the terminal. The Grignard reagent is then allowed to react with the halide of the compound (β-2).

Some of the compounds (β-4) are commercially available, and some of them are prepared by a known method.

For example, benzene, biphenyl, terphenyl, thiophene, bithiophene, terthiophene, quaterthiophene, and naphthalene, or the mono- or di-halides thereof, and the like are commercially available.

The benzene-skeleton-containing molecules can be prepared, for example, by the following method. However, heterocyclic ring-skeleton-containing molecules containing N, Si, Ge, P, Sn, Ti or Zr are also prepared by a method similar to that for the benzene-skeleton-containing molecules.

In preparing the benzene-skeleton-containing molecules, it is effective to use the Grignard reaction after halogenating the reactive sites in benzene. It is possible to control the number of benzene rings by the method. Alternatively, coupling by using a suitable metal catalyst (Cu, Al, Zn, Zr, Sn, or the like) may be used for preparation thereof, instead of the Grignard reagent.

A method of preparing a benzene-skeleton-containing molecule will be described below as an example. Only reaction from benzene trimer to (3+m)-oligomer is shown in the following Preparative Example. However, it is possible to form a benzene-skeleton-containing molecule other than 4- to 7-oligomers, by using a starting material different in unit number.

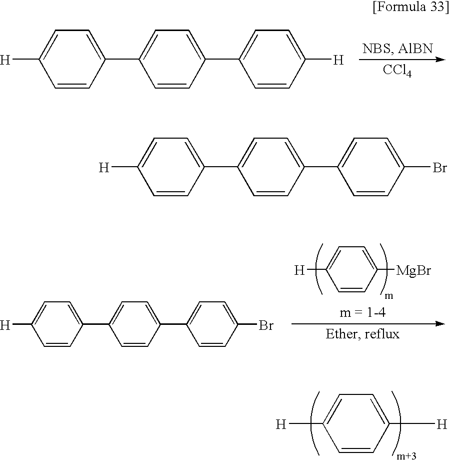

For example, a thiophene-skeleton-containing molecule can be prepared by the following method. However, it is also possible to prepare a heterocyclic ring-skeleton-containing molecule containing O or N by a method similar to that for the thiophene-skeleton-containing molecule.

In preparing the thiophene-skeleton-containing molecule, it is effective to use the Grignard reaction after halogenating the reactive sites in thiophene. It is possible to control the number of thiophene rings by the method. Alternatively, coupling by using a suitable metal catalyst (Cu, Al, Zn, Zr, Sn, or the like) may be used for preparation thereof, instead of the Grignard reagent.

Further in preparing the thiophene-skeleton-containing molecule, the following preparation method may be used, instead of the method of using the Grignard reagent.

Specifically, the 2′- or 5′-position of thiophene is first halogenated (for example, chlorinated). An example of the halogenation methods is treatment with one equivalence of N-chlorosuccinimide or phosphorus oxychloride (POCl₃). The solvent for use then is, for example, a chloroform-acetic acid (AcOH) liquid mixture or DMF. Alternatively, it is possible to connect thiophene molecules at the halogenated sites to each other, by allowing the halogenated thiophenes to react in a DMF solvent in the presence of a catalyst, tris(triphenylphosphine) nickel: (PPh₃)₃Ni.

Coupling of the halogenated thiophene with divinylsulfone gives its 1,4-diketone derivative. Subsequently, reflux of a dry toluene solution is performed in the presence of Lawesson reagent (LR) or P₄S₁₀ overnight in the case of the former compound or for about three hours in case of the latter compound in order to lead to ring closure, giving a thiophene-skeleton-containing molecule with the number of thiophene rings increased by one than total number of thiophene rings in the coupled thiophene.

Thus, it is possible to increase the number of thiophene rings by using the reaction of thiophene above.

A method of preparing the thiophene-skeleton-containing molecule will be shown below as an example. Only reactions from thiophene dimer to tetramer and from thiophene trimer to 6- or 7-oligomer are described in the following Preparative Example. However, it is possible to form thiophene-skeleton-containing molecules other than the 4-, 6- or 7-oligomer in reaction of a thiophene difference in unit number. For example, it is possible to form a thiophene pentamer by coupling of 2-chlorothiophene, chlorination of 2-chlorobithiophene with NCS, and subsequent reaction of the chlorinated product with 2-chlorinated derivative of thiophene trimer. In addition, chlorination of thiophene tetramer with NCS leads also to a 8- or 9-thiophene oligomer.

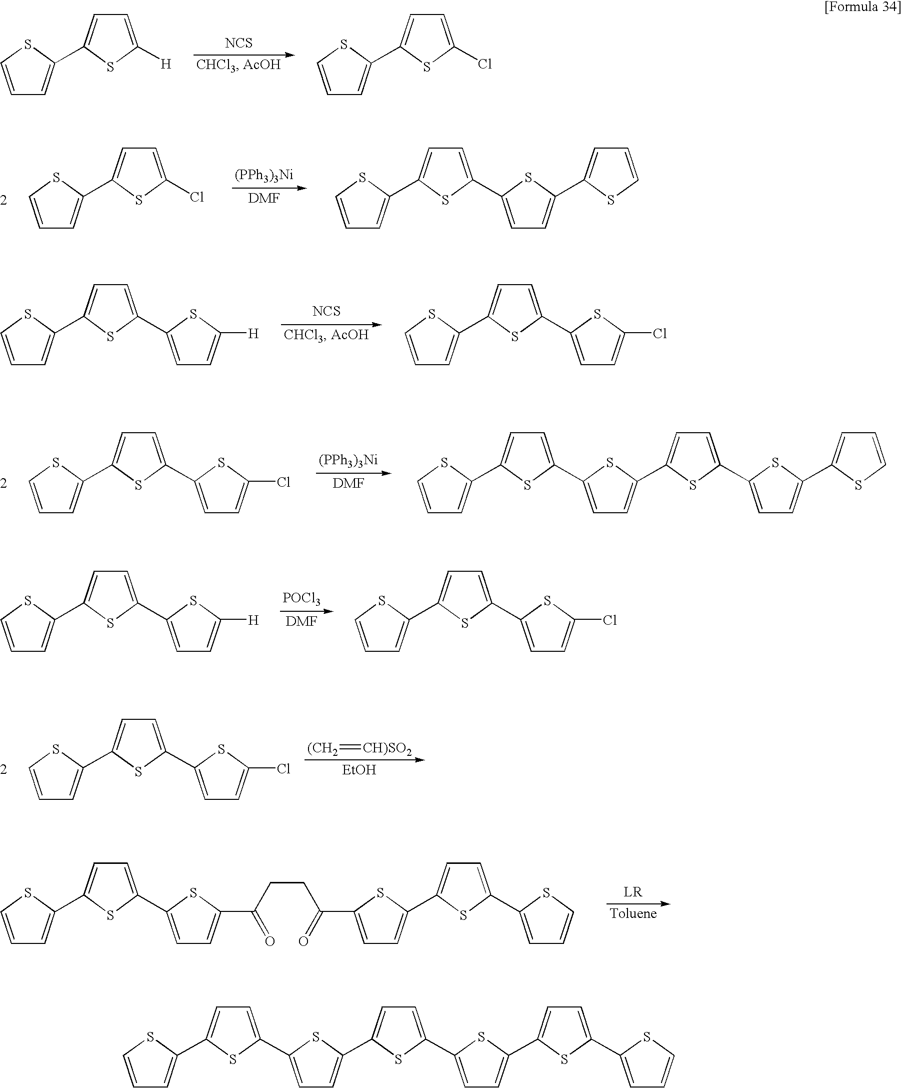

It is also possible to prepare a molecule containing benzene and thiophene skeletons, for example, in combination of the methods of preparing the benzene-skeleton-containing molecule and of preparing the thiophene-skeleton-containing molecule.

Alternatively, an acene-skeleton-containing molecule can be prepared, for example, by the following method.

The method of producing an acene-skeleton-containing molecule is, for example, to repeat processings of substituting the hydrogen atom bound to the carbon atom at a predetermined position of a raw material compound with triflate group, allowing it to react with a furan or the derivative thereof, and oxidizing the product. An example of the method of producing an acene skeleton by the method will be shown below.

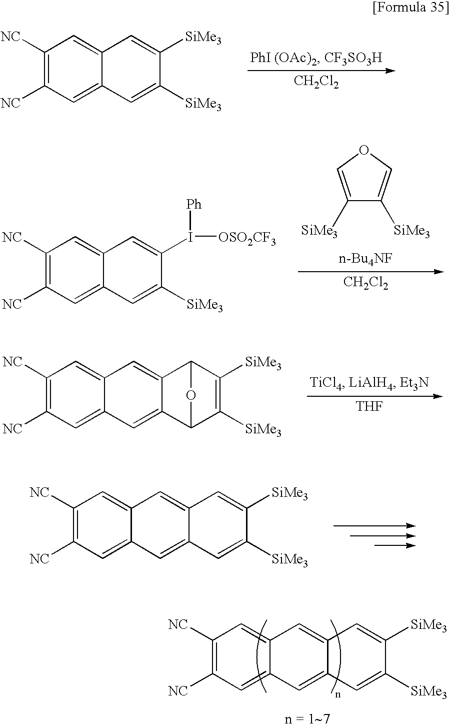

(Organic Thin Film and Method of Forming the Same)

It is possible to form an organic thin film (in particular, unimolecular film) by using the organic silane compound (I) or the organic silane compound (α) according to the present invention. The unimolecular film is preferably formed on a substrate.

The organic silane compound (I) or (α) is adsorbed on the substrate via a chemical bond of the silyl group (in particular, silanol bond (—Si—O—)). Therefore, in the unimolecular film of the organic silane compound (I) or (α), the compound molecule is oriented with its silyl group in the substrate side and its R¹ or Z groups in the film-surface side. As a result, such a unimolecular film has high orientation (crystallinity) of the compound molecule and thus, superior peeling resistance. In addition, because the organic silane compound (I) has a π-electron-conjugated R¹ group and the organic silane compound (α) has a π-electron-conjugated Z group, the unimolecular film obtained is superior in electrical characteristics such as carrier mobility efficiency, for example, when used as the organic layer (thin film) in an organic device such as organic thin film transistor, organic photoelectric conversion element, or organic electroluminescence element.

Examples of the raw materials for the substrate include element semiconductors such as silicon and germanium; compound semiconductors such as gallium arsenide and zinc selenide; quartz glass; and polymeric materials such as polyethylene, polyethylene terephthalate, and polytetrafluoroethylene. Alternatively, the substrate may be made of an inorganic material commonly used as the electrode of semiconductor device, and may have an organic material film additionally on the surface. The substrate in the present invention preferably has hydrophilic groups such as hydroxyl or carboxyl, in particular hydroxyl, on the surface and the hydrophilic groups may be formed by processing on the surface of the substrate, if it does not have such groups. Hydrophilization on the substrate can be carried out, for example, by immersion of the substrate in a hydrogen peroxide-sulfuric acid mixed solution or by UV-light irradiation.

Hereinafter, the method of forming an organic thin film by using the organic silane compound (I) or (α) will be described.

First in forming the organic thin film, the silyl group of the organic silane compound (I) or (α) is allowed to react with the substrate surface by hydrolysis, forming a unimolecular film adsorbed (bound) directly to the substrate. Specifically, a method such as so-called LB method (Langmuir Blodgett method), dipping method, or coating method may be used.

More specifically, for example in the LB method, an organic silane compound (I) or (α) is dissolved in a nonaqueous organic solvent, and the solution obtained is applied dropwise onto the surface of water previously pH-adjusted, forming a thin film thereon. The groups X¹ to X³ in the silyl group of the organic silane compound (I) or the groups R² to R¹⁴ in the silyl group of the organic silane compound (α) are then hydrolyzed into hydroxyl groups. Subsequent application of pressure on the water surface in the state and withdrawal of the substrate having the hydrophilic groups (in particular, hydroxyl groups) on a surface leads to reaction of the silyl groups in the organic silane compound (I) or (α) with the substrate, giving a unimolecular film bound via chemical bonds (in particular, silanol bonds) to the substrate. The pH of water on which the solution is applied dropwise is preferably adjusted to a pH allowing hydrolysis of the groups X¹ to X³ or R¹² to R¹⁴.

Alternatively, for example in the dipping or coating method, an organic silane compound (I) or (α) is dissolved in a nonaqueous organic solvent, and a substrate having hydrophilic groups (in particular, hydroxyl groups) on the surface is dipped in the solution obtained and then withdrawn therefrom, or the solution obtained is coated on the surface of the base material. The groups X¹ to X³ in the silyl group of the organic silane compound (I) or the groups R¹² to R¹⁴ in the silyl group of the organic silane compound (α) are hydrolyzed into hydroxyl groups by the water present in a trace amount in the nonaqueous solvent. Then the silyl groups in the organic silane compound (I) or (α) react with the substrate when the dipped substrate is held as it is for a particular period, forming chemical bonds (in particular, silanol bonds) and consequently giving a unimolecular film. When the groups X¹ to X³ or the groups R¹² to R¹⁴ are not hydrolyzed, it is preferable to add pH-adjusted water in a small amount to the solution.

The nonaqueous organic solvent is not particularly limited, if it is incompatible with water and dissolves the organic silane compound (α), and examples thereof include hexane, chloroform, carbon tetrachloride, and the like.

After the unimolecular film is formed, the unreacted organic silane compound is normally removed from the unimolecular film by using a nonaqueous organic solvent. After water washing, drying at room temperature or under heat leads to fixation of the organic thin film.

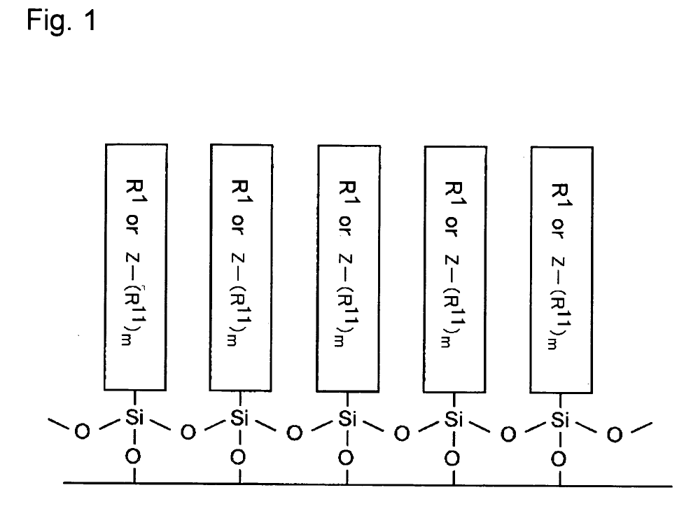

The organic thin film obtained may be used directly as an electric material or may be processed additionally, for example, by electrolytic polymerization. Use of the organic silane compound (I) or (α) according to the present invention leads to formation of a Si—O—Si network in the organic thin film as shown in FIG. 1, decrease in the distance between neighboring molecules, and increase in orientation (crystallization). In addition, when the units R¹ or Z-(R¹¹)ₘ are connected linearly, the units in neighboring molecules are not bound to each other, leading to further decrease in the distance between neighboring molecules and giving a highly crystallized organic thin film.

Hereinafter, the organic silane compound and the production method thereof according to the present invention will be described more specifically with reference to Examples.

### EXAMPLES

### Preparative Example 1

Preparation of the Terselenophene Trichlorosilane represented by General Formula (I) above (X¹═X²═X³═Cl; Y═Se; R²═R³═H, and n1=3) (Grignard Method)

The compound was prepared according to the synthetic route 1. Specifically, 50 ml of chloroform and 70 mM of selenophene were first placed in a 100-ml round-bottomed flask, and the mixture was cooled to a temperature of 0° C.; 20 M of NBS (N-bromosuccinimide) was added thereto, and the mixture was stirred for 1 hour. After extraction with purified water, the product was purified at 80° C. under reduced pressure, to give 2-bromoselenophene. Then under a nitrogen environment, 5 ml of dry THF and 30 mM of 2-bromoselenophene were placed in a 50-ml round-bottomed flask; magnesium is added thereto; and the mixture was stirred for 2 hours. Then, 5 ml of dry THF containing a catalyst Ni(dppp)Cl₂(dichloro[1,3-bis(diphenylphosphino)propane]nickel (II)) and 30 mM of 2-bromoselenophene was added thereto, and the mixture was allowed to react at 0° C. for 12 hours. After extraction with purified water, the product was purified by flash chromatography, to give diselenophene.

Then, 50 ml of chloroform and 70 mM of diselenophene were placed in a 100-ml round-bottomed flask; the mixture was cooled to a temperature of 0° C.; 70 M of NBS (N-bromosuccinimide) was added; and the mixture was stirred for 1 hour. After extraction with purified water, the product was purified at 80° C. under reduced pressure, to give 2-bromodiselenophene (yield: 50%). Then, 5 ml of dry THF and 7 mM of 2-bromoselenophene, which is an intermediate for preparation of diselenophene, were placed in a 50-ml round-bottomed flask under a nitrogen environment; magnesium was added; and the mixture was stirred for 2 hours. Then, 5 ml of dry THF containing a catalyst Ni(dppp)Cl₂(dichloro[1,3-bis(diphenylphosphino)propane]nickel (II)) and 3 mM of 2-bromodiselenophene was added thereto; and the mixture was allowed to react at 0° C. for 12 hours. After extraction with purified water, the product was purified by flash chromatography, to give terselenophene (30%).

Further, 50 ml of chloroform and 5 mM of terselenophene were placed in a 100-ml round-bottomed flask; the mixture was cooled to a temperature of 0° C.; and 20M of NBS was added thereto; and the mixture was stirred for 1 hour. After extraction with purified water, the product was purified at 80° C. under reduced pressure, to give 2-bromoterselenophene. Further under a nitrogen environment, 5 ml of dry THF, 2-bromoterselenophene, and magnesium were placed in a 200-ml round-bottomed flask, and the mixture was stirred for 2 hours, to give a Grignard reagent.

20 mM of SiCl₄ (tetrachlorosilane) and 50 ml of toluene were placed in a 200-ml round-bottomed flask equipped with a stirrer, a reflux condenser, a thermometer, and a dropping funnel; the mixture was cooled in an ice bath; the Grignard reagent was added dropwise at an internal temperature of 20° C. or lower over 2 hours; and then the mixture was aged at 30° C. for 1 hour (Grignard reaction).

The reaction solution was then filtered under reduced pressure for removal of magnesium chloride; toluene and unreacted tetrachlorosilane were stripped off from the filtrate; and the solution was distilled, to give the title compound at a yield of 40%.

Infrared absorption spectrum measurement of the compound obtained showed an absorbance derived from SiC bond at 1080 cm⁻¹, indicating that the compound had a SiC bond.

Further, nuclear magnetic resonance (NMR) measurement of the compound was performed. Since the direct NMR measurement of the compound obtained was not possible because of the high reactivity of the compound, the compound was allowed to react with ethanol (with accompanied generation of hydrogen chloride) allowing the terminal chlorine group to be replaced with an ethoxy group before measurement.

7.7 ppm (s) (1H, derived from selenophene ring)

7.2 ppm to 7.1 ppm (m) (6H, derived from selenophene ring)

3.8 ppm to 3.7 ppm (m) (6H, derived from methylene group in ethoxy group)

1.30 ppm to 1.20 ppm (m) (9H, derived from methyl group in ethoxy group)

These results confirmed that the compound obtained was the title compound.

### Preparative Example 2

### Preparation of the Quaterselenophene Trimethoxysilane Represented by General Formula (1) (X¹═X²═X³═OCH₃; Y═Se, R²═R³═H; and n1=4)

First, 5 ml of dry THF and 5 mM of the intermediate 2-bromodiselenophene obtained in Preparative Example 1 were placed in a 50 ml round-bottomed flask under a nitrogen environment; magnesium was added thereto; and the mixture was stirred for two hours. Then, 5 ml of dry THF containing a catalyst Ni (dppp) Cl₂ and 5 mM of 2-bromodiselenophene was added thereto, and the mixture was allowed to react at 0° C. for 10 hours. After extraction with purified water, the product was purified by flash chromatography, to give quaterselenophene (35%).

Then, 50 ml of chloroform and 70 mM of the intermediate quaterselenophene obtained in Preparative Example 2 were placed in a 100-ml round-bottomed flask; the mixture was cooled to 0° C. and, after addition of 70 M of NBS, stirred for 1 hour. After extraction with purified water, the product was purified at 80° C. under reduced pressure, to give 2-bromoquaterselenophene (yield 40%). Under a nitrogen environment, 5 ml of dry THF, 2-bromoquaterselenophene, and magnesium were placed in a 200-ml round-bottomed flask, and the mixture was stirred for 2 hours, to give a Grignard reagent.

Further, 10 mM of trimethoxychlorosilane and 30 ml of toluene were placed in a 100-ml round-bottomed flask equipped with a stirrer, a reflux condenser, a thermometer, and dropping funnel and cooled in an ice bath; the Grignard reagent was added dropwise thereto over two hours; and the mixture was aged at 30° C. for 1 hour (Grignard reaction).

The reaction solution was then filtered under reduced pressure for removal of magnesium chloride; toluene and unreacted trimethoxychlorosilane were stripped off from the filtrate; and the solution was distilled, to give the title compound at a yield of 45%.

Infrared absorption spectrum measurement of the compound obtained showed an absorbance derived from SiC bond at 1090 cm⁻¹, indicating that the compound had a SiC bond.

Further, nuclear magnetic resonance (NMR) measurement of the compound was performed.

7.8 ppm (s) (1H, derived from selenophene ring)

7.4 ppm to 7.3 ppm (m) (8H, derived from selenophene ring)

3.50 ppm (m) (9H, derived from methyl group)

These results confirmed that the compound obtained was the title compound.

### Preparative Example 3

### Preparation of the Octiselenophene Triethoxysilane Represented by General Formula (1) (X¹═X²═X³═OC₂H₅; Y═Se; R²═R³═H; and n1=8)

First, 5 ml of dry THF and 5 mM of the intermediate 2-bromoquaterselenophene obtained in Preparative Example 2 were placed in a 50-ml round-bottomed flask under a nitrogen environment; magnesium was added thereto; and the mixture was stirred for three hours. Then, 5 ml of dry THF containing a catalyst Ni(dppp)Cl₂ and 5 mM of 2-bromoquaterselenophene was added thereto, and the mixture was allowed to react at 0° C. for 12 hours. After extraction with purified water, the product was purified by flash chromatography, to give octiselenophene (30%).

Subsequently, 50 ml of chloroform and 10 mM of the octiselenophene above were placed in a 100-ml round-bottomed flask; the mixture was cooled to a temperature of 0° C.; 10 M of NBS was added thereto; and the mixture was stirred for 1 hour. After extraction with purified water, the product was purified at 80° C. under reduced pressure, to give 2-bromoquaterselenophene.

Separately, 5 ml of dry THF, 2-bromooctiselenophene, and magnesium were placed in 200-ml round-bottomed flask under a nitrogen environment, and the mixture was stirred for 2 hours, to give a Grignard reagent. Further, 10 mM of triethoxylchlorosilane and 30 ml of toluene were placed in a 100-ml round-bottomed flask equipped with a stirrer, a reflux condenser, a thermometer, and dropping funnel and cooled in an ice bath; the Grignard reagent was added thereto over 2 hours; and, after dropwise addition, the mixture was aged at 30° C. for 1 hour (Grignard reaction). The reaction solution was then filtered under reduced pressure for removal of magnesium chloride; toluene and unreacted triethoxylchlorosilane were stripped off from the filtrate; and the solution was distilled, to give the title compound at a yield of 35%.

Infrared absorption spectrum measurement of the compound obtained showed an absorbance derived from SiC bond at 1080 cm⁻¹, indicating that the compound had a SiC bond.

Further, nuclear magnetic resonance (NMR) measurement of the compound was performed.

7.7 ppm (s) (1H, derived from selenophene ring)

7.2 ppm to 7.1 ppm (m) (16H, derived from selenophene ring)

3.8 ppm to 3.7 ppm (m) (6H, derived from methylene group in ethoxy group)

1.3 ppm to 1.2 ppm (m) (9H, derived from methyl group in ethoxy group)

These results confirmed that the compound obtained was the title compound.

### Preparative Example 4

### Preparation of the Silole Compound Having a Substituent Group (Methyl Group) Represented by General Formula (1) (X¹═X²═X³═Cl; Y═Si; R²═H; R³═CH₃; and n1=2)

The compound was prepared according to the synthetic route 2. Specifically, 20 mM of 2,5-bromo-3,4-dimethyl-1H-silole was first dissolved in ethanol solvent; the solution was added into an ethanol solution containing 22 mM of butyllithium, converting the 5-bromo group into a Li group; and a THF solution of 12 mM of CuCN was added thereto, allowing oxidative addition of copper. Subsequently, 30 mM of trimethylethylenediamine and 100 mM of para-dinitrobenzene were added for coupling between two molecules, to give 5′-dibromo-3,4,3′,4′-tetramethyl-1H,1H′-[2,2′]bisilolyl at a yield of 60%.

Then, 5 ml of dry THF, 5,5′-dibromo-3,4,3′,4′-tetramethyl-1H,1H′-[2,2′]bisilolyl above, and magnesium were placed and stirred for one hour in a 200-ml round-bottomed flask under a nitrogen environment, to give a Grignard reagent having Mg only at the 5-position. Separately, 10 mM of trimethylchlorosilane and 30 ml of THF were placed in a 100-ml round-bottomed flask equipped with a stirrer, a reflux condenser, a thermometer, and dropping funnel and cooled in an ice bath; the Grignard reagent was added thereto; and the mixture was aged at 30° C. for one hour. Then, the reaction solution was filtered under reduced pressure for removal of magnesium chloride; and toluene and unreacted trimethylchlorosilane were stripped off from the filtrate, to give 5-trimethylsilyl-5′-bromo-3,4,3′,4′-tetramethyl-1H,1H′-[2,2′]bisilolyl. Subsequently, the 5-trimethylsilyl-5′-bromo-3,4,3′,41-tetramethyl-1H,1H′-[2,2′]bisilolyl was dissolved in 20 ml of THF; the trimethylsilyl group was eliminated with PHN⁺Me₃F⁻, to give 5-bromo-3,4,3′,4′-tetramethyl-1H,1H′-[2,2′]bisilolyl. Further, 5 ml of dry THF, the 5-bromo-3,4,3′,4′-tetramethyl-1H,1H′-[2,2′]bisilolyl, and magnesium were placed and stirred for one hour in a 200-ml round-bottomed flask under a nitrogen environment, to give a Grignard reagent; 10 mM of tetrachlorosilane and 30 ml of THF were placed in a 100-ml round-bottomed flask equipped with a stirrer, a reflux condenser, a thermometer, and dropping funnel and cooled in an ice bath; the Grignard reagent was added thereto; and the mixture was aged at 30° C. for one hour. The reaction solution was then filtered under reduced pressure for removal of magnesium chloride; THF and unreacted tetrachlorosilane were stripped off from the filtrate, to give the title compound at a yield of 30%.

Infrared absorption spectrum measurement of the compound obtained showed an absorbance derived from SiC bond at 1080 cm⁻¹, indicating that the compound had a SiC bond. Further, nuclear magnetic resonance (NMR) measurement of the compound obtained was performed.

Since the direct NMR measurement of the compound obtained was not possible because of the high reactivity of the compound, the compound was allowed to react with ethanol (with accompanied generation of hydrogen chloride) allowing the terminal chlorine group to be replaced with an ethoxy group before measurement.

4.5 ppm (m) (1H, derived from silole ring)

4.3 to 4.2 ppm (m) (4H, derived from hydrogen directly bound to Si)

3.8 ppm to 3.7 ppm (m) (6H, derived from methylene group in ethoxy group)

2.0 ppm to 1.9 ppm (m) (12H, derived from methyl group on silole ring)

1.5 ppm to 1.4 ppm (m) (9H, derived from methyl group in ethoxy group)

These results confirmed that the compound obtained was the title compound.

### Preparative Example 5

### Preparation of the Silole Compound Having a Substituent Group (Methyl Group) Represented by General Formula (1) (X¹═X²═X³═Cl; Y═Si; R²═H; R³═CH₃; and n1=6)

First, an intermediate 5,5′-dibromo-3,4,3′,4′-tetramethyl-1H,1H′-[2,2′]bisilolyl was prepared in a similar manner to Preparative Example 4. The intermediate was then processed according to the synthetic route 3. Specifically, 5 ml of dry THF, 5 mM of 5,5′-dibromo-3,4,3′,4′-tetramethyl-1H,1H′-[2,2′]bisilolyl and magnesium were first placed and stirred for 5 hours in a 200-ml round-bottomed flask under a nitrogen environment, to give a Grignard reagent. Then, 10 mM of 5-bromo-3,4,3′,4′-tetramethyl-1H,1H′-[2,2′]bisilolyl and 30 ml of THF were placed in a 100-ml round-bottomed flask equipped with a stirrer, a reflux condenser, a thermometer, and dropping funnel and cooled in an ice bath; the Grignard reagent was added thereto; and the mixture was allowed to react at 0° C. for 15 hours. After extraction with purified water, the product was purified by flash chromatography to give an intermediate (A).

Subsequently, 50 ml of chloroform and 10 mL of the intermediate (A) were placed and cooled to a temperature of 0° C. in a 100-ml round-bottomed flask, and, after addition of 10 M of NBS, the mixture was stirred for one hour. After extraction with purified water, the product was purified at 80° C. under reduced pressure, to give the intermediate (A) of which the hydrogen atom at the terminal is substituted with bromine. 5 ml of dry THF, 5 mM of the terminal-brominated intermediate (A) and magnesium were placed and stirred for one hour in a 200-ml round-bottomed flask under a nitrogen environment, to give a Grignard reagent. 5 mM of tetrachlorosilane and 30 ml of THF were placed and cooled in an ice bath in a 100-ml round-bottomed flask equipped with a stirrer, a reflux condenser, a thermometer, and dropping funnel; the Grignard reagent was added thereto; and the mixture was aged at 30° C. for one hour. The reaction solution was then filtered under reduced pressure for removal of magnesium chloride; and THF and unreacted tetrachlorosilane were stripped off from the filtrate, to give the title compound at a yield of 20%.

Infrared absorption spectrum measurement of the compound obtained showed an absorbance derived from SiC bond at 1100 cm⁻¹, indicating that the compound had a SiC bond.

Further, nuclear magnetic resonance (NMR) measurement of the compound obtained was performed. Since the direct NMR measurement of the compound obtained was not possible because of the high reactivity of the compound, the compound was allowed to react with ethanol (with accompanied generation of hydrogen chloride) allowing the terminal chlorine group to be replaced with an ethoxy group before measurement.

4.4 ppm (m) (1H, derived from silole ring)

4.3 ppm to 4.2 ppm (m) (12H, derived from hydrogen directly bound to Si)

3.8 ppm to 3.7 ppm (m) (6H, derived from methylene group in ethoxy group)

2.1 ppm to 2.0 ppm (m) (36H, derived from methyl group on silole ring)

1.5 ppm to 1.4 ppm (m) (9H, derived from methyl group in ethoxy group)

These results confirmed that the compound obtained was the title compound.

### Preliminary Example 1

### Preparation of 2-bromoterthiophene

1 mM of terthiophene was dissolved in carbon tetrachloride in a 100-ml glass flask equipped with a stirrer, a reflux condenser, a thermometer, and a dropping funnel; NBS and AIBN (azoisobutylonitrile) were added thereto; the mixture was stirred for 2.5 hours, and then, filtered under reduced pressure, to give 2-bromoterthiophene.

### Preparative Example 6

### Preparation of the Silole Compound Having a Substituent Group (Methyl Group) Represented by General Formula (5) (X¹═X²═X³═OC₂H₅, Y⁶═Y⁸═S; Y⁷═Si; R²═H;

R³ on central five-membered ring=CH₃; R³ on five-membered rings at terminals=H; n2=n4=3; and n3=2)

First, an intermediate 5,5′-dibromo-3,4,3′,4′-tetramethyl-1H,1H′-[2,2′]bisilolyl was prepared in a similar manner to Preparative Example 4. The intermediate was then processed according to the second Formula or latter of the synthetic route 4 (m=3, n=2). Specifically, 0.5 mM of n-butyllithium was placed and cooled to −78° C. in a 500-ml glass flask equipped with a stirrer, a reflux condenser, a thermometer, and dropping funnel; the 5,5′-dibromo-3,4,3′,4′-tetramethyl-1H,1H′-[2,2′]bisilolyl was added dropwise from the dropping funnel over 30 minutes, converting it into its lithium compound; 1.5 mM of bis(pinacolato) diboron was added; and the mixture was allowed to react for 12 hours, while heated gradually from a container internal temperature of −78° C. to room temperature. After reaction, a diboron compound (C) was prepared by addition of 2M hydrochloric acid. The diboron compound (C) was then dissolved in a toluene solution, and the solution was added into a 200-ml glass flask equipped with a stirrer, a reflux condenser, a thermometer, and dropping funnel containing 3 mol % of Pd(PPh)₃ and a small amount of aqueous sodium carbonate solution; the toluene solution of 2-bromoterthiophene prepared in Preliminary Example 1 was added dropwise therein from the dropping funnel; the mixture was allowed to react at 85° C. for 12 hours, to give an intermediate (D) having silole rings directly bound to the terthiophene at the 2- and 5″-positions.

Subsequently, 50 ml of chloroform and 5 mM of the intermediate (D) were placed in a 100-ml round-bottomed flask and cooled to a temperature of 0° C.; 5 M of NBS was added thereto; and the mixture was stirred for one hour. After extraction with purified water, the product was purified under reduced pressure at 80° C., to give an intermediate (E). 5 ml of dry THF, 5 mM of the intermediate (E), and magnesium were placed and stirred for one hour in a 200-ml round-bottomed flask under a nitrogen environment, to give a Grignard reagent. Then, 5 mM of triethoxylchlorosilane and 30 ml of THF were placed in a 100-ml round-bottomed flask equipped with a stirrer, a reflux condenser, a thermometer, and dropping funnel and cooled in an ice bath; the Grignard reagent was added thereto; and the mixture was aged at 30° C. for one hour. The reaction solution was then filtered under reduced pressure for removal of magnesium chloride; and THF and unreacted tetrachlorosilane were stripped off from the filtrate, to give the title compound at a yield of 15%.

Infrared absorption spectrum measurement of the compound obtained showed an absorbance derived from SiC bond at 1090 cm⁻¹, indicating that the compound had a SiC bond.

Further, nuclear magnetic resonance (NMR) measurement of the compound obtained was performed.

7.7 ppm (s) (1H, derived from thiophene ring)

7.3 ppm to 7.2 ppm (m) (12H, derived from thiophene ring)

4.5 ppm to 4.3 ppm (m) (4H, derived from hydrogen directly bound to Si)

3.7 ppm to 3.6 ppm (m) (6H, derived from methylene group in ethoxy group)

2.2 ppm to 2.1 ppm (m) (12H, derived from methyl group on silole ring)

1.4 ppm to 1.3 ppm (m) (9H, derived from methyl group in ethoxy group)

These results confirmed that the compound obtained was the title compound.

### Preliminary Example 2

### Preparation of 4-bromoquaterphenyl

0.5 mM of quaterphenyl was dissolved in carbon tetrachloride in a 100-ml glass flask equipped with a stirrer, a reflux condenser, a thermometer, and dropping funnel; NBS and AIBN were added; and the mixture was stirred for three hours and filtered under reduced pressure, to give bromoquaterphenyl.

### Preparative Example 7

### Preparation of the Silole Compound Having a Substituent Group (Methyl Group) Represented by General Formula (6) (X¹═X²═X³═Cl; Y⁹═Si; Z¹=Z²=C; R³ of central five-membered ring=CH₃; R³ on terminal six-membered rings=H; n2=n4=4; and n3=1)

The compound was prepared according to the synthetic route 5 (m=4, n=1). Specifically, the title compound was prepared in a similar manner to Preparative Example 6, except that 2-bromoterthiophene was replaced with 4-bromoquaterphenyl, the reaction was carried out at 80° C. for 15 hours instead of at 85° C. for 12 hours, 5,5′-dibromo-3,4,3′,4′-tetramethyl-1H,1H′-[2,2′]bisilolyl was replaced with 2,5-dibromo-3,4-dimethyl-1H-silole, and triethoxychlorosilane was replaced with tetrachlorosilane.

Infrared absorption spectrum measurement of the compound obtained showed an absorbance derived from SiC bond at 1100 cm⁻¹, indicating that the compound had a SiC bond.

Further, nuclear magnetic resonance (NMR) measurement of the compound obtained was performed. Since the direct NMR measurement of the compound obtained was not possible because of the high reactivity of the compound, the compound was allowed to react with ethanol (with accompanied generation of hydrogen chloride) allowing the terminal chlorine group to be replaced with an ethoxy group before measurement.

7.6 ppm to 7.5 ppm (m) (8H, derived from benzene ring)

7.5 ppm to 7.4 ppm (m) (20H, derived from benzene ring)

7.2 ppm (m) (1H, derived from benzene ring)

7.1 ppm (m) (4H, derived from benzene ring)

4.3 ppm (m) (2H, derived from hydrogen directly bound to Si)

3.8 ppm to 3.7 ppm (m) (6H, derived from methylene group in ethoxy group)

2.1 ppm to 2.0 ppm (m) (12H, derived from methyl group on silole ring)

1.5 ppm to 1.4 ppm (m) (9H, derived from methyl group in ethoxy group)

These results confirmed that the compound obtained was the title compound.

Evaluation of Energy Level

The LUMO energy level of each of the organic silane compounds obtained in Preparative Examples 1 to 7 is estimated to be −2.6 eV from molecular orbital calculation. On the other hand, the LUMO energy level of each of the organic silane compounds, as determined by photoelectronic spectrometry, was −2.5 eV or less. The results confirmed that any one of the compounds had a LUMO level more stabilized than that of the compound containing no hetero atom. Obviously, the organic silane compound above had a band gap smaller than that of the compound containing no hetero atom, and thus, the organic silane compound was a compound having a high semiconductive property.

### Preparative Example 8

### Preparation of the Organic Silane Compound Represented by General Formula (αI-I)

The title compound was prepared according to the following method. First, 0.5 mole of metal magnesium and 300 ml of THF (tetrahydrofuran) were placed in a 500-ml glass flask equipped with a stirrer, a reflux condenser, a thermometer, and dropping funnel under a nitrogen environment; 0.5 mole of 2-chlorobenzimidazole was added thereto dropwise at 50 to 60° C. from the dropping funnel over 2 hours; and after dropwise addition, the mixture was aged at 65° C. for 2 hours, to give a Grignard reagent. Then, 1.0 mole of SiCl₄ (tetrachlorosilane) and 300 ml of toluene were placed in a 1-liter glass flask and cooled in an ice bath; the Grignard reagent was added thereto at an internal temperature of 20° C. or lower over 2 hours; and, after dropwise addition, the mixture was aged at 30° C. for 1 hour. After reaction, the reaction solution was filtered under reduced pressure for removal of magnesium chloride, and toluene and unreacted tetrachlorosilane were removed from the filtrate, to give the title compound at a yield of 50%.

Infrared absorption spectrum measurement of the compound obtained showed an absorbance derived from SiC bond at 1080 cm⁻¹, indicating that the compound had a SiC bond.

Further, nuclear magnetic resonance (NMR) measurement of the compound was performed. Since the direct NMR measurement of the compound obtained was not possible because of the high reactivity of the compound, the compound was allowed to react with ethanol (with accompanied generation of hydrogen chloride) allowing the terminal chlorine group to be replaced with an ethoxy group before measurement.

7.7 ppm (m) (2H, aromatic)

7.2 ppm (m) (2H, aromatic)

5.2 ppm (m) (1H, hydrogen bound directly to nitrogen atom)

3.8 ppm (m) (6H, ethoxy group methylene group)

1.4 ppm (m) (9H, ethoxy group methyl group)

These results indicated that the compound obtained was the compound represented by General Formula (αI-1).

### Preparative Example 9

### Preparation of the Organic Silane Compound Represented by General Formula (αV-I)

The title compound was prepared according to the following method. First, 0.5 mole of metal magnesium and 30 ml of THF were placed under a nitrogen environment in a similar manner to Preparative Example 8; 0.5 mole of 2-chlorophenothiazine was added thereto; and the mixture was allowed to react at 60° C. for two hours, to give a Grignard reagent. Then, the Grignard reagent was added to a toluene solution containing 1.0 mole of chlorotrimethoxysilane, and the mixture was allowed to react at 30° C. for one hour. After reaction, the reaction solution was filtered under reduced pressure for removal of magnesium chloride, and toluene and unreacted chlorotrimethoxysilane were removed from the filtrate, to give the title compound at a yield of 55%.

Infrared absorption spectrum measurement of the compound obtained showed an absorbance derived from SiC bond at 1090 cm⁻¹, indicating that the compound had a SiC bond.

Further, nuclear magnetic resonance (NMR) measurement of the compound was performed.

7.0 ppm to 6.1 ppm (m) (7H, aromatic)

5.3 ppm (1H, hydrogen bound directly to nitrogen atom)

3.7 ppm (m) (9H, methoxy group methyl group)

These results indicated that the compound obtained was the compound represented by General Formula (αV-1).

### Preparative Example 10

### Preparation of the Organic Silane Compound Represented by General Formula (αIII-1)

The title compound was prepared according to the following method. In a similar manner to Preparative Example 8, 0.3 mole of metal magnesium and 30 ml of THF were first placed in a flask under a nitrogen environment; 0.3 mole of 2-chloroquinoline was added thereto; and the mixture was allowed to react at 60° C. for 1.5 hours, to give a Grignard reagent. Then, the Grignard reagent was added to a THF solution containing 0.5 mole of tetrachlorosilane, and the mixture was allowed to react at 30° C. for 1 hour. After reaction, the reaction solution was filtered under reduced pressure for removal of magnesium chloride, and THF and unreacted tetrachlorosilane were removed from the filtrate, to give the title compound at a yield of 55%.

Infrared absorption spectrum measurement of the compound obtained showed an absorbance derived from SiC bond at 1090 cm⁻¹, indicating that the compound had a SiC bond.

Further, nuclear magnetic resonance (NMR) measurement of the compound was performed. Since the direct NMR measurement of the compound obtained was not possible because of the high reactivity of the compound, the compound was allowed to react with ethanol (with accompanied generation of hydrogen chloride) allowing the terminal chlorine group to be replaced with an ethoxy group before measurement.

7.8 ppm to 7.2 ppm (m) (6H, aromatic)

3.7 ppm (m) (6H, ethoxy group methylene group)

1.6 ppm (m) (9H, ethoxy group methyl group)

These results indicated that the compound obtained was the compound represented by General Formula (αIII-1).

### Preparative Example 11

### Preparation of the Organic Silane Compound Represented by General Formula (αVI-1)

The title compound was prepared according to the following method. First, 1 M NBS was added to a carbon tetrachloride solution containing 0.5 mM of 4,7-dimethyl-1,10-phenanthroline; the mixture was stirred for two hours, and filtered under reduced pressure, to give 3-bromo-4,7-dimethyl-1,10-phenanthroline. Subsequently in a similar manner to Preparative Example 8, 0.3 mole of metal magnesium and 30 ml of THF were first placed in a flask under a nitrogen environment; 3-bromo-4,7-dimethyl-1,10-phenanthroline above was added thereto; the mixture was allowed to react at 60° C. for 1.5 hours, to give a Grignard reagent. The Grignard reagent was then added to a THF solution containing 0.5 mole of chlorotrimethoxysilane; and the mixture was allowed to react at 30° C. for one hour. After reaction, the reaction solution was filtered under reduced pressure for removal of magnesium chloride, and THF and the unreacted compound were removed from the filtrate, to give the title compound at a yield of 50%.

Infrared absorption spectrum measurement of the compound obtained showed an absorbance derived from SiC bond at 1090 cm⁻¹, indicating that the compound had a SiC bond. Further, nuclear magnetic resonance (NMR) measurement of the compound was performed.

8.6 ppm (m) (2H, aromatic)

7.7 ppm (m) (1H, aromatic)

7.5 ppm (m) (2H, aromatic)

3.6 ppm (m) (9H, methoxy group methyl group)

2.4 ppm (m) (6H, methyl group)

These results indicated that the compound obtained was the compound represented by General Formula (αVI-1).

### Preparative Example 12

### Preparation of the Organic Silane Compound Represented by General Formula (αII-1)

The title compound was prepared according to the following method. First in a similar manner to Preparative Example 11, 1 M NBS and AIBN were added to a carbon tetrachloride solution containing 0.5 mM of 2-hydroxydibenzofuran; the mixture was stirred for two hours and filtered under reduced pressure, to give 2-bromodibenzofuran. Then in a similar manner to Preparative Example 8, 0.3 mole of metal magnesium and 30 ml of THF were placed in a flask under a nitrogen environment; 2-bromodibenzofuran above was added thereto; the mixture was allowed to react at 55° C. for two hours, to give a Grignard reagent. The Grignard reagent was then added to a THF solution containing 0.5 mole of chlorotriethoxysilane, and the mixture was allowed to react at 20° C. for one hour. After reaction, the reaction solution was filtered under reduced pressure for removal of magnesium chloride, and THF and unreacted compound were removed from the filtrate, to give the title compound at a yield of 60%.

Infrared absorption spectrum measurement of the compound obtained showed an absorbance derived from SiC bond at 1080 cm⁻¹, indicating that the compound had a SiC bond.

Further, nuclear magnetic resonance (NMR) measurement of the compound was performed.

7.5 ppm (m) (4H, aromatic)

7.5 ppm (m) (3H, aromatic)

3.5 ppm (m) (6H, ethoxy group methylene group)

1.6 ppm (m) (9H, ethoxy group methyl group)

These results indicated that the compound obtained was the compound represented by General Formula (αII-1).

### Preparative Example 13

### Preparation of the Organic Silane Compound Represented by General Formula (αII-3)

The title compound was prepared according to the following method. First in a similar manner to Preparative Example 11, 1 M NBS and AIBN were added to a carbon tetrachloride solution containing 0.5 mM of 2-hydroxycarbazole; and the mixture was stirred for two hours and filtered under reduced pressure, to give 2-bromocarbazole. Subsequently in a similar manner to Preparative Example 8, 0.3 mole of metal magnesium and 30 ml of THF were placed in a flask under a nitrogen environment, 2-bromocarbazole above was added thereto; and the mixture was allowed to react at 60° C. for two hours, to give a Grignard reagent. The Grignard reagent was then added to a THF solution containing 0.5 mole of tetrachlorosilane, and the mixture was allowed to react at 20° C. for one hour. After reaction, the reaction solution was filtered under reduced pressure for removal of magnesium chloride, and THF and unreacted compound were removed from the filtrate, to give the title compound at a yield of 60%.

Infrared absorption spectrum measurement of the compound obtained showed an absorbance derived from SiC bond at 1080 cm⁻¹, indicating that the compound had a SiC bond.

Further, nuclear magnetic resonance (NMR) measurement of the compound was performed. Since the direct NMR measurement of the compound obtained was not possible because of the high reactivity of the compound, the compound was allowed to react with ethanol (with accompanied generation of hydrogen chloride), converting the terminal chlorine into an ethoxy group, before measurement.

8.5 ppm (m) (1H, hydrogen bound directly to nitrogen atom)

7.6 ppm to 7.5 ppm (m) (4H, aromatic)

7.2 ppm (m) (3H, aromatic)

3.5 ppm (m) (6H, ethoxy group methylene group)

1.4 ppm (m) (9H, ethoxy group methyl group)

These results indicated that the compound obtained was the compound represented by General Formula (αII-3).

### Preparative Example 14

### Preparation of the Organic Silane Compound Represented by General Formula (αIV-1)

The title compound was prepared according to the following method. First in a similar manner to Preparative Example 11, 1M NBS and AIBN were added to a carbon tetrachloride solution containing 0.4 mM of 2,3-dimethylquinoxaline; the mixture was stirred for 1.5 hours and filtered under reduced pressure, to give 2,3-dimethyl-7-bromoquinoxaline. Then in a similar manner to Preparative Example 8, 0.2 mole of metal magnesium and 30 ml of THF were placed in a flask under a nitrogen environment, 2,3-dimethyl-7-bromoquinoxaline above was added thereto; and the mixture was allowed to react at 50° C. for four hours, to give a Grignard reagent. The Grignard reagent was then added to a THF solution containing 0.3 moles of chlorotriethoxysilane, and the mixture was allowed to react at 20° C. for 1.5 hours. After reaction, the reaction solution was filtered under reduced pressure for removal of magnesium chloride, and THF and unreacted compound were removed from the filtrate, to give the title compound at a yield of 55%.

Infrared absorption spectrum measurement of the compound obtained showed an absorbance derived from SiC bond at 1085 cm⁻¹, indicating that the compound had a SiC bond.

Further, nuclear magnetic resonance (NMR) measurement of the compound was performed.

8.0 ppm (m) (2H, aromatic)

7.6 ppm (m) (1H, aromatic)

3.5 ppm (m) (6H, ethoxy group methylene group)

2.4 ppm (m) (6H, methyl group)

1.4 ppm (m) (9H, ethoxy group methyl group)

These results indicated that the compound obtained was the compound represented by General Formula (αIV-1).

### Preparative Example 15

### Preparation of the Organic Silane Compound Represented by General Formula (αI-2)

The title compound was prepared according to the following method. First, 1 M NBS and AIBN were added to a carbon tetrachloride solution containing 0.5 M of terphenyl, and the mixture was stirred for 8 hours and filtered under reduced pressure, to give dibromoterphenyl. Then, 0.2 mole of metal magnesium was added to a THF solution containing 0.2M of dibromoterphenyl above in a nitrogen atmosphere; the mixture was allowed to react at 50° C. for 2 hours, to give a Grignard reagent (A); 0.2 M of 2-chlorobenzimidazole was added to the Grignard reagent THF solution; the mixture was allowed to react at 20° C. for one hour, to give an intermediate (B).

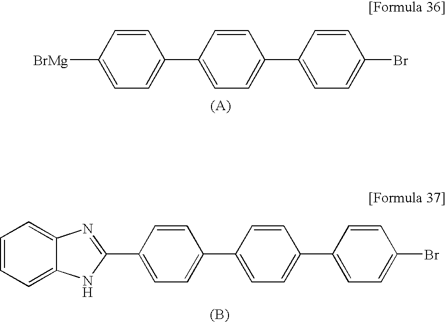

Further, the intermediate (B) wad dissolved in THF, allowing reaction with metal magnesium at 55° C. for two hours, to give a Grignard reagent; 0.1 M of chlorotriethoxysilane was added thereto; and the mixture was allowed to react at 25° C. for two hours, to give the title compound at a yield of 40%.

Infrared absorption spectrum measurement of the compound obtained-showed an absorbance derived from SiC bond at 1075 cm⁻¹, indicating that the compound had a SiC bond.

Further, nuclear magnetic resonance (NMR) measurement of the compound was performed.

7.7 ppm (m) (2H, aromatic, derived from benzimidazole)

7.6 ppm to 7.5 ppm (m) (10H, aromatic, derived from terphenyl)

7.4 ppm (m) (2H, aromatic, derived from terphenyl)

7.3 ppm (m) (2H, aromatic, derived from benzimidazole)

3.5 ppm (m) (6H, ethoxy group methylene group)

1.4 ppm (m) (9H, ethoxy group methyl group)

These results indicated that the compound obtained was the compound represented by General Formula (αI-2).

Organic silane compounds different in phenylene group number and organic silane compounds different in the group derived from the terminal fused polycyclic compound can be prepared by a similar method.

### Preparative Example 16

### Preparation of the Organic Silane Compound Represented by General Formula (αV-2)

The title compound was prepared according to the following method. First, 1 M NBS and AIBN were added to a carbon tetrachloride solution containing 0.5M of quaterthiophene; and the mixture was stirred for six hours and filtered under reduced pressure, to give dibromoquaterthiophene. Then, 0.2 moles of metal magnesium was added to a THF solution containing 0.2 M of the dibromoquaterthiophene under a nitrogen atmosphere; the mixture was allowed to react at 60° C. for three hours, to give a Grignard reagent having magnesium bound only to one bromo group, as in Preparative Example 15; the solution was added to a THF solution containing 0.2 M of 2-chlorophenothiazine and the mixture was allowed to react at 20° C. for 1 hour, to form an intermediate (C).

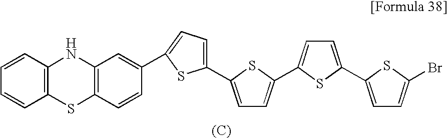

Further, the intermediate (C) was dissolved in THF; metal magnesium was added thereto; the mixture was allowed to react at 55° C. for two hours, to give a Grignard reagent; and 0.1 M of chlorotrimethoxysilane was added thereto, and the mixture was allowed to react at 25° C. for two hours, to give the title compound at a yield of 40%.

Infrared absorption spectrum measurement of the compound obtained showed an absorbance derived from SiC bond at 1090 cm⁻¹, indicating that the compound had a SiC bond.

Further, nuclear magnetic resonance (NMR) measurement of the compound was performed.

8.5 ppm (m) (1H, hydrogen bound directly to nitrogen atom)

7.1 ppm (m) (8H, thiophene ring)

6.9 ppm (m) (5H, aromatic)

6.8 ppm (m) (2H, aromatic)

3.5 ppm (m) (9H, methoxy group methyl group)

These results indicated that the compound obtained was the compound represented by General Formula (αV-2).

Organic silane compounds different in thiophene group number and organic silane compounds different in the group derived from the terminal fused polycyclic compound can be prepared by a similar method.

### Preparative Example 17

### Preparation of the Organic Silane Compound Represented by General Formula (αII-2)

The title compound was prepared according to the following method. First, 0.5 mole of metal magnesium was added to a THF solution containing 0.5 M of the intermediate in Preparative Example 12, 2-bromodibenzofuran under a nitrogen atmosphere; the mixture was allowed to react at 50° C. for three hours, to give a Grignard reagent; 0.5 M of 1-bromonaphthalene was then added thereto; and the mixture was allowed to react at 20° C. for one hour, to give 3-naphthalen-2-yl-dibenzofuran.

Further, 0.5 M of 3-naphthalen-2-yl-dibenzofuran above was added to a carbon tetrachloride solution containing 1 M NBS and AIBN, and the mixture was allowed to react at 55° C. for 2 hours, to give an intermediate (D).

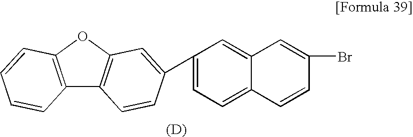

0.5 M of chlorotriethoxysilane was added thereto, and the mixture was allowed to react at 20° C. for 2 hours, to give the title compound at a yield of 30%.

Infrared absorption spectrum measurement of the compound obtained showed an absorbance derived from SiC bond at 1090 cm⁻¹, indicating that the compound had a SiC bond.

Further, nuclear magnetic resonance (NMR) measurement of the compound was performed.

7.8 ppm (m) (4H, aromatic)

7.5 ppm (m) (5H, aromatic)

7.3 ppm (m) (2H, aromatic)

7.2 ppm (m) (2H, aromatic)

3.6 ppm (m) (6H, ethoxy group methylene group)

1.5 ppm (m) (9H, ethoxy group methyl group)

These results indicated that the compound obtained was the compound represented by General Formula (αII-2).

Organic silane compounds different in acene skeleton number and organic silane compounds different in the group derived from the terminal fused polycyclic compound can be prepared by a similar method.

### INDUSTRIAL APPLICABILITY

The organic silane compound according to the present invention is superior in electroconductive property (semiconductive property), orientation (crystallinity and regularity) and adhesiveness to substrate, and useful in production of semiconductor electronic devices such as TFT, solar battery, fuel cell, and sensor.

1-19. (canceled)

20. A π-electron-conjugated organic silane compound represented by General Formula (I):
R¹—SiX¹X²X³ (I)
(wherein, R¹ represents an organic group having a monocyclic heterocyclic unit containing an atom selected from the group consisting of Si, Ge, Sn, P, Se, Te, Ti and Zr; and each of X¹ to X³ represents a group giving a hydroxyl group by hydrolysis).

21. The π-electron-conjugated organic silane compound according to claim 20, wherein R¹ represents an organic group having an other monocyclic heterocyclic unit or/and a monocyclic aromatic hydrocarbon ring unit additionally.

22. The π-electron-conjugated organic silane compound according to claim 21, wherein the other monocyclic heterocyclic unit is a thiophene ring unit and the monocyclic aromatic hydrocarbon ring unit is a benzene ring unit.

23. The π-electron-conjugated organic silane compound according to claim 20, wherein the total number of the units contained in R¹ is 1 to 9.

24. The π-electron-conjugated organic silane compound according to claim 20, wherein R¹ represents an organic group containing a vinylene group between units.

25. The π-electron-conjugated organic silane compound according to claim 20, wherein X¹ to X³ each independently represents a halogen atom or a lower alkoxy group.

26. A method of producing a π-electron-conjugated organic silane compound, comprising
allowing a compound represented by General Formula (II):
R¹—Li (II)
(wherein, R¹ represents an organic group having a monocyclic heterocyclic unit containing an atom selected from the group consisting of the elements in the 4A, 4B, 5B and 6B groups of the long-form periodic table) to react with a compound represented by General Formula (III):
X⁴—SiX¹X²X³ (III)
(wherein, each of X¹ to X³ represents a group giving a hydroxyl group by hydrolysis; and X⁴ represents a hydrogen or halogen atom or a lower alkoxy group).

27. A method of producing a π-electron-conjugated organic silane compound, comprising
allowing a compound represented by General Formula (IV):
R¹—MgX⁵ (IV)
(wherein, R¹ is an organic group having monocyclic heterocyclic unit containing an atom selected from the group consisting of the elements in the 4A, 4B, 5B and 6B groups of the long-form periodic table; and X⁵ represents a halogen atom) to react with a compound represented by General Formula (III):
X⁴—SiX¹X²X³ (III)
(wherein, each of X¹ to X³ is a group giving a hydroxyl group by hydrolysis; and X⁴ represents a hydrogen or halogen atom or a lower alkoxy group) in Grignard reaction.

28. The method of producing the π-electron-conjugated organic silane compound according to claim 26, wherein operations of halogenating the compound having a monocyclic heterocyclic unit containing an atom (Y⁰) selected from the group consisting of the elements in the 4A, 4B, 5B and 6B groups of the long-form periodic table at a particular site and allowing the halogenated compound obtained to react with a Grignard reagent containing a Y₀ atom-containing monocyclic heterocyclic unit in Grignard reaction are repeated in order to control the number of the Y₀ atom-containing monocyclic heterocyclic units in R¹.

29. A π-electron-conjugated organic silane compound (excluding 3-triethoxysilylquinoline) represented by General Formula (α):
Z-(R¹¹)ₘ—SiR¹²R¹³R¹⁴ (α)
(wherein, Z represents a monovalent organic group derived from a fused polycyclic heterocyclic compound having 2 to 10 of fused rings of five-membered rings and/or six-membered rings; R¹¹ represents a bivalent organic group; m is an integer of 0 to 10; and R¹² to R¹⁴ each independently represent a halogen atom or an alkoxy group having 1 to 4 carbon atoms).

30. A π-electron-conjugated organic silane compound represented by General Formula (αI): 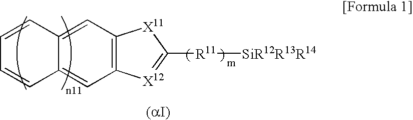
(wherein, X¹¹ represents a carbon, nitrogen, oxygen or sulfur atom and X¹² represents a carbon or nitrogen atom (however, X¹¹ and X¹² are not carbon atoms at the same time); n11 is an integer of 0 to 8; R¹¹ represents a bivalent organic group; m is an integer of 0 to 10; and R¹² to R¹⁴ each independently represent a halogen atom or an alkoxy group having 1 to 4 carbon atoms).

31. A π-electron-conjugated organic silane compound represented by General Formula (αII): 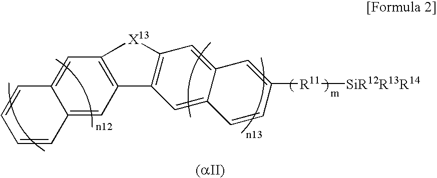
(wherein, X¹³ represents a nitrogen, oxygen or sulfur atom; n12 and n13 are integers satisfying 0≦n12+n13≦7; R¹¹ represents a bivalent organic group; m is an integer of 0 to 10; and R¹² to R¹⁴ each independently represent a halogen atom or an alkoxy group having 1 to 4 carbon atoms).

32. A π-electron-conjugated organic silane compound (excluding 3-triethoxysilylquinoline) represented by General Formula (αIII): 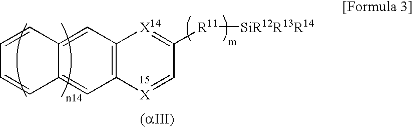
(wherein, X¹⁴ and X¹⁵ each independently represent a carbon or nitrogen atom (however, X¹⁴ and X¹³ are not carbon atoms at the same time); n14 is an integer of 0 to 8; R¹¹ represents a bivalent organic group; m is an integer of 0 to 10; and R¹² to R¹⁴ each independently represent a halogen atom or an alkoxy group having 1 to 4 carbon atoms).

33. A π-electron-conjugated organic silane compound represented by General Formula (αIV): 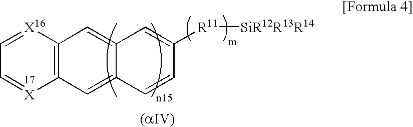
(wherein, X¹⁶ and X¹⁷ each independently represent a carbon or nitrogen atom (however, X¹⁶ and X¹⁷ are not carbon atoms at the same time); n15 is an integer of 0 to 8; R¹¹ represents a bivalent organic group; m is an integer of 0 to 10; and R¹² to R¹⁴ each independently represent a halogen atom or an alkoxy group having 1 to 4 carbon atoms).

34. A π-electron-conjugated organic silane compound represented by General Formula (αV): 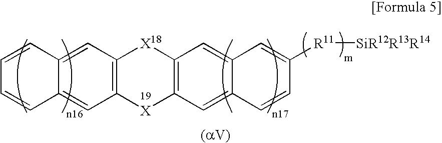
(wherein, X¹⁸ and X¹⁹ each independently represent a carbon, nitrogen, oxygen or sulfur atom (however, X¹⁸ and X¹⁹ are not carbon atoms at the same time); n16 and n17 are integers satisfying 0≦n16+n17≦7; R¹¹ represents a bivalent organic group; m is an integer of 0 to 10; and R¹² to R¹⁴ each independently represent a halogen atom or an alkoxy group having 1 to 4 carbon atoms).

35. A π-electron-conjugated organic silane compound represented by General Formula (αVI): 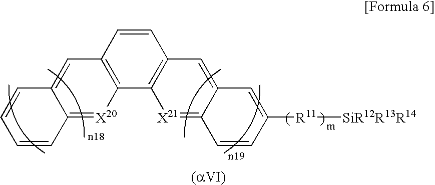
(wherein, X²⁰ and X²¹ each independently represent a carbon or nitrogen atom (however, X²⁰ and X²¹ are not carbon atoms at the same time); n18 and n19 are integers satisfying 0≦n18+n19≦7; R¹¹ represents a bivalent organic group; m is an integer of 0 to 10; and R¹² to R¹⁴ each independently represent a halogen atom or an alkoxy group having 1 to 4 carbon atoms).

36. The π-electron-conjugated organic silane compound according to claim 29, wherein R¹¹ is a bivalent organic group selected from the group consisting of the groups represented by General Formulae (i) to (iv); 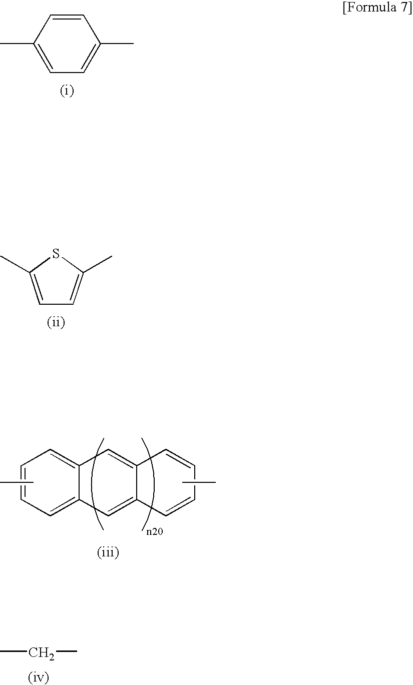
(wherein, n20 is an integer of 0 to 8).

37. A method of producing π-electron-conjugated organic silane compound, comprising
allowing a compound represented by General Formula (β):
Z-(R¹¹)ₘ—MgX³⁰ (β)
(wherein, Z represents a monovalent organic group derived from a fused polycyclic heterocyclic compound having 2 to 10 of fused rings of five-membered rings and/or six-membered rings; R¹¹ represents a bivalent organic group; m is an integer of 0 to 10; and X³⁰ represents a halogen atom) to react with a compound represented by General Formula (γ):
X³¹—SiR¹²R¹³R¹⁴ (γ)
(wherein, X³¹ represents a hydrogen or halogen atom or an alkoxy group having 1 to 4 carbon atoms; and R¹² to R¹⁴ each independently represent a halogen atom or an alkoxy group having 1 to 4 carbon atoms) in Grignard reaction.
